(19) United States
(12) Patent Application Publication
(10) Pub. No.: US 2020/0257285 A1
(43) Pub. Date: Aug. 13, 2020

(54) USER ASSISTANCE SYSTEM AND VEHICLE CONTROL SYSTEM

(71) Applicant: TOYOTA JIDOSHA KABUSHIKI KAISHA, Toyota-shi (JP)

(72) Inventor: Hiroyuki TOKITA, Toyota-shi (JP)

(73) Assignee: TOYOTA JIDOSHA KABUSHIKI KAISHA, Toyota-shi (JP)

(21) Appl. No.: 16/733,310

(22) Filed: Jan. 3, 2020

(30) Foreign Application Priority Data
Feb. 12, 2019 (JP) 2019-023024

(51) Int. Cl. G05D 1/00; G01C 21/36; G08G 1/0967

(52) U.S. Cl. CPC G05D 1/0016; G01C 21/3605; G05D 2201/0213; G05D 1/0022; G08G 1/0967

(57) ABSTRACT

A user assistance system includes: an assistance information reception unit configured to receive, from a user terminal of a user who uses a place where the user works in cooperation with another user, assistance information indicating that the user asks for assistance; an information generation unit configured to generate control information for controlling a vehicle to be used by the user when the assistance information reception unit receives the assistance information; and a communication unit configured to transmit the control information to the vehicle.

### CROSS-REFERENCE TO RELATED APPLICATION

This application is based upon and claims the benefit of priority of the prior Japanese Patent Application No. 2019-023024, filed on Feb. 12, 2019, the entire contents of which are incorporated herein by reference.

### TECHNICAL FIELD

The present disclosure relates to a user assistance system and a vehicle control system.

### BACKGROUND

There has been known an art for impartially imposing a cost of using a co-working space on a plurality of users using the co-working space as disclosed in, for example, Japanese Patent Application Publication No. 2017-228274 (hereinafter, referred to as Patent Document 1).

Here, the above-described co-working space can be defined as a place where freelance workers who are not employed by organizations and are skilled in different fields are able to work in cooperation with each other while sharing their skills and information with each other in the same space. Details of the definition of the co-working space will be described later. Among such co-working spaces, there are co-working spaces with a day-care center for kids. Thus, some of the users of a co-working space (hereinafter, referred to as a user) use the co-working space with their kids. Some users may temporarily leave a co-working space because of their work while leaving their kids to a day-care center. In such a case, when the kid left in the care of the day-care center becomes ill, the user is requested to pick up the kid from the day-care center. Depending on the condition of the kid, the user may go to a medical facility with the kid after arriving at the co-working space.

However, the co-working space is a place for the user to work in cooperation with other users, and does not always have information on a medical facility. Thus, even if the user intends to go to a medical facility from the co-working space, the user may be unable to move from the co-working space smoothly.

In some co-working spaces, a community manager may be always stationed. The community manager plans a networking event for a plurality of users in different fields, and assists building of a community among users.

However, the work of the community manager is not limited to such community-building, and there is a variety of work that requires the community manager to move from the co-working space. For example, the community manager has jobs such as a preliminary visit to the venue where the networking event is to be held. Thus, when the community manager becomes busy with work, the work is delayed, and the community manager may be unable to move from the co-working space smoothly.

### SUMMARY

It is therefore an object of the present disclosure to assist smooth transportation of the user of a co-working space.

The above object is achieved by a user assistance system including: an assistance information reception unit configured to receive, from a user terminal of a user who uses a place where the user works in cooperation with another user, assistance information indicating that the user asks for assistance; an information generation unit configured to generate control information for controlling a vehicle to be used by the user when the assistance information reception unit receives the assistance information; and a communication unit configured to transmit the control information to the vehicle.

In the above user assistance system, the user assistance system may further include a facility information storage unit configured to store facility information including a location of a medical facility to which a person who is left in care by the user can be taken, wherein the information generation unit may determine, as a destination, a location of a medical facility where the user is to get out of the vehicle based on the facility information when the assistance information reception unit receives the assistance information including information indicating that picking up of the person who is left in care by the user is accepted, and the communication unit may transmit the control information including the destination.

In the above user assistance system, the information generation unit may obtain, from the user terminal, schedule information including a schedule of the user managed by the user terminal and determines, as a destination, a destination location included in the schedule based on the schedule information when the assistance information reception unit receives the assistance information, and the communication unit may transmit the control information including the destination.

In the above user assistance system, the user assistance system may further include a situation management unit configured to manage utilization situation information including a utilization situation of the place, wherein the information generation unit may provide the utilization situation to the user terminal of which a user is to use the place based on the utilization situation information, and when detecting that the place that the user is to use is changed to another place where the user works in cooperation with another user, may determine the another place as a destination from a current location of the user, and the communication unit may transmit the control information including the destination.

In the above user assistance system, the user assistance system may further include a vehicle assignment unit configured to assign the vehicle to the user based on an operation to request assignment of the vehicle on the user terminal, wherein the communication unit may transmit, to the vehicle that is assigned, the control information including the destination when assignment of the vehicle is completed.

In the above user assistance system, the information generation unit may determine whether the assistance information includes information indicating that there is urgency of assignment of the vehicle when the assistance information reception unit receives the assistance information, and when determining that the assistance information includes the information indicating that there is urgency of assignment of the vehicle, the information generation unit may set, to the vehicle assignment unit, a priority mode that preferentially assigns the vehicle.

In the above user assistance system, the information generation unit may obtain weather information, and when determining that a route from a planned boarding location of the user to the destination includes a dangerous driving environment based on the weather information, may identify the dangerous driving environment, and the communication unit may transmit the control information including the dangerous driving environment.

In the above user assistance system, the communication unit may transmit, to the user terminal, the control information including the destination when the information generation unit determines that the user terminal is located in an interior of the vehicle.

In the above user assistance system, the information generation unit may obtain, from the vehicle, driving assistance information for assisting the user in driving the vehicle, and when determining that the driving assistance information is present, may generate switching information for switching from a first driving mode, which does not use the driving assistance information, to a second driving mode, which uses the driving assistance information, and the communication unit may transmit the control information including the switching information.

In the above user assistance system, the information generation unit may generate adjustment information for adjusting an environment in an interior of the vehicle when detecting a trigger for adjusting the environment in the interior of the vehicle, and the communication unit may transmit the control information including the adjustment information.

The above object is achieved by a vehicle control system including: an information reception unit configured to receive, from a user assistance system that generates control information for controlling a vehicle to be used by a user and transmits the control information to the vehicle when receiving assistance information indicating that the user asks for assistance from a user terminal of the user who uses a place where the user works in cooperation with another user, the control information; and a vehicle controller configured to control the vehicle based on the control information.

### BRIEF DESCRIPTION OF THE DRAWINGS

FIG. 1 is a diagram for describing examples of a user assistance system and a vehicle control system in accordance with a first embodiment;

FIG. 2 illustrates a hardware configuration of a first user terminal;

FIG. 3 illustrates a hardware configuration of a first assistance server of the user assistance system;

FIG. 4 illustrates a hardware configuration of the vehicle control system;

FIG. 5 is an exemplary block diagram of the first user terminal and the vehicle control system;

FIG. 6 is an exemplary block diagram of the user assistance system;

FIG. 7A illustrates membership information, FIG. 7B illustrates service management information, FIG. 7C illustrates vehicle management information, and FIG. 7D illustrates member presence/absence information;

FIG. 8A illustrates facility information, FIG. 8B illustrates vehicle assignment information, and FIG. 8C illustrates utilization situation information;

FIG. 9 is an exemplary sequence diagram of a first process in accordance with a first embodiment;

FIG. 10 illustrates a registration screen;

FIG. 11 is an exemplary sequence diagram (No. 1) of a second process in accordance with the first embodiment;

FIG. 12 is an exemplary sequence diagram (No. 2) of the second process in accordance with the first embodiment;

FIG. 13 illustrates an assistance screen;

FIG. 14 illustrates a pick-up screen;

FIG. 15 illustrates a vehicle assignment screen;

FIG. 16 illustrates another example of the vehicle assignment screen;

FIG. 17A is an exemplary sequence diagram of a third process, and FIG. 17B is an exemplary sequence diagram of a fourth process;

FIG. 18 is an exemplary sequence diagram of a fifth process;

FIG. 19 is a diagram for describing examples of a user assistance system and a vehicle control system in accordance with a second embodiment;

FIG. 20 is an exemplary sequence diagram of the first process in accordance with the second embodiment;

FIG. 21 illustrates schedule information;

FIG. 22 is an exemplary sequence diagram of the second process in accordance with the second embodiment;

FIG. 23 is a diagram for describing examples of a user assistance system and a vehicle control system in accordance with a third embodiment;

FIG. 24 is an exemplary sequence diagram of the first process in accordance with the third embodiment;

FIG. 25 illustrates a check screen;

FIG. 26 is an exemplary sequence diagram of the second process in accordance with the third embodiment; and

FIG. 27 illustrates a delivery screen.

### DETAILED DESCRIPTION

Hereinafter, with reference to the accompanying drawings, embodiments of the present disclosure will be described. As described above, a co-working space is defined as, for example, a place where freelance workers (for example, sole proprietors) who are not employed by organizations and are skilled in different fields can build a community and work in cooperation with each other while sharing their skills and information with each other, but the definition of the co-working space is not limited to the above definition. For example, the co-working space may be defined as a place where freelance workers who are not employed by organizations and are skilled in different fields and employees (for example, company employees) who are employed by organizations and are skilled in different fields can build a community and work in cooperation with each other while sharing their skills and information with each other. The co-working space can be used for a fee or free of charge temporarily, in the short-term, or in the long-term, depending on the contract for use of the co-working space. With use of the co-working space described above, first through third embodiments will be described.

### First Embodiment

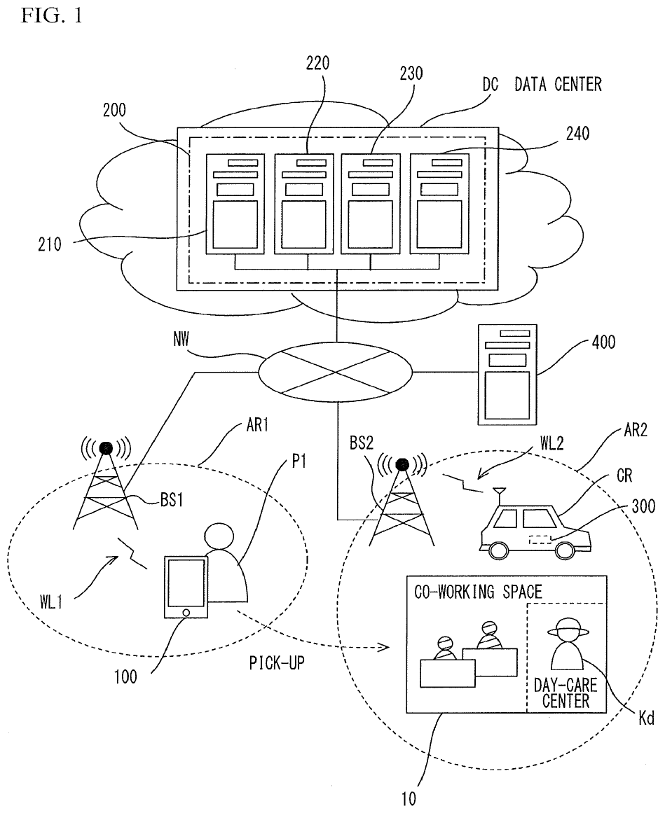

FIG. 1 is a diagram for describing examples of a user assistance system 200 and a vehicle control system 300 in accordance with a first embodiment. As illustrated in FIG. 1, the user assistance system 200 is installed in a data center DC providing a cloud service. The user assistance system 200 includes a first assistance server 210, a second assistance server 220, a third assistance server 230, and a fourth assistance server 240. The first assistance server 210, the second assistance server 220, the third assistance server 230, and the fourth assistance server 240 are connected to each other over a wire communication network such as a local area network (LAN). The first assistance server 210, the second assistance server 220, the third assistance server 230, and the fourth assistance server 240 are connected to a communication network NW. The communication network NW is, for example, the Internet.

A base station BS1 is connected to the communication network NW. When a first user terminal 100 is included within the radio communication range AR1 of the base station BS1, the base station BS1 is able to communicate with the first user terminal 100 by wireless communication WL1. In FIG. 1, a smartphone is illustrated as an example of the first user terminal 100, but the first user terminal 100 may be a tablet terminal. For example, a communication standard such as Long Term Evolution (LTE) is used for wireless communication WL1.

A base station BS2 is also connected to the communication network NW. When a vehicle CR capable of wide area communication is included within the radio communication range AR2 of the base station BS2, the base station BS2 is able to communicate with the vehicle by wireless communication WL2. The vehicle CR may be a private car of a user P1, or may be a car owned by a business operator that assigns the vehicle CR. The communication standard used for wireless communication WL2 may be the same as or different from that for wireless communication WL1.

Furthermore, a weather server 400 is connected to the communication network NW. The weather server 400 stores and manages weather information. The weather information includes the weather, the temperature, the precipitation, and the precipitation probability of each area. The weather server 400 provides the weather information to the user assistance system 200 upon request of the user assistance system 200. Details will be described later, but the user assistance system 200 may generate, with use of the weather information, control information for controlling the vehicle CR.

Here, the first user terminal 100 is used by the user P1 of a co-working space 10. The user P1 may be a freelance worker or employee who does jobs in the co-working space 10. The user P1 brings a kid Kd of the user P1 to the co-working space 10 as a guardian, and leaves the kid Kd at a day-care center, but is away from the co-working space 10 for certain reasons. In FIG. 1, the user P1 is not within the radio communication range AR2 but within the radio communication range AR1. Alternatively, the user P1 may be in a place that is within the radio communication range AR2 but is different from the co-working space 10.

Nursery staff (not illustrated) is stationed at the day-care center and looks after the physical condition of the kid Kd at regular intervals. When the physical condition of the kid Kd is not good, the user P1 is requested to pick up the kid Kd. The nursery staff may request the user P1 to pick up the kid Kd by a telephone installed in the day-care center, or may request the user P1 to pick up the kid Kd by an e-mail or a social networking service (SNS) through the mobile terminal carried by the nursery staff. When the mobile terminal of the nursery staff can cooperate with the user assistance system 200, the nursery staff may request the user P1 to pick up the kid Kd through the user assistance system 200. When the user P1 is requested to pick up the kid Kd by the nursery staff, the user P1 informs the nursery staff of whether the user P1 accepts or declines to pick up the kid Kd.

When the user P1 informs the nursery staff that the user P1 accepts to pick up the kid Kd, the user P1 operates the first user terminal 100 to access the user assistance system 200 and use a first service of the user assistance system 200. Details will be described later, but the first service is a service that provides the address of the nearest medical facility to the co-working space 10 to the vehicle control system 300 of the vehicle CR, which is the private car of the user P1 or a car to be assigned, when the user P1 accepts to pick up the kid Kd. When the kid Kd has a personal medical facility, the address of the personal medical facility may be provided. A car navigation system (hereinafter, simply referred to as a navigation system) is installed in the vehicle CR. When the address of the medical facility is provided, the current location of the vehicle CR is set as a location where the user P1 is to get on the vehicle, and the address of the medical facility is set as a location where the user P1 is to get out of the vehicle. Thus, when the user P1 arrives at the co-working space 10, picks up the kid Kd from the nursery staff, and gets on the vehicle CR with the kid Kd, the route from the current location to the medical facility is already identified. Therefore, the user P1 can move to the medical facility smoothly.

Hereinafter, details of the first user terminal 100, the user assistance system 200, and the vehicle control system 300 will be described.

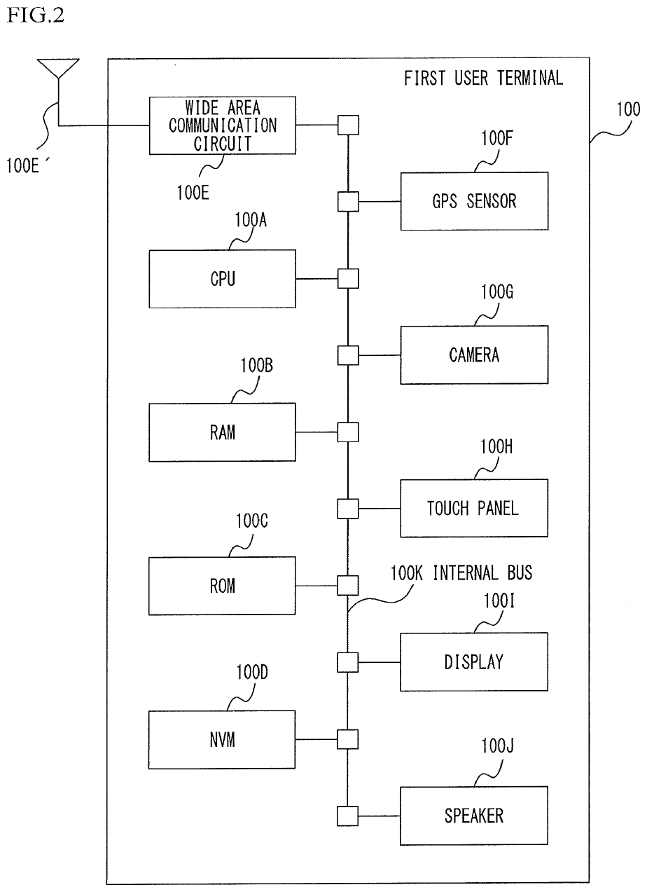

FIG. 2 illustrates a hardware configuration of the first user terminal 100. As illustrated in FIG. 2, the first user terminal 100 includes a central processing unit (CPU) 100A as a processor, a random access memory (RAM) 100B, a read only memory (ROM) 100C, a non-volatile memory (NVM) 100D, and a wide area communication circuit 100E. The wide area communication circuit 100E is a hardware circuit that enables wide area wireless communication. An antenna 100E′ is connected to the wide area communication circuit 100E.

The first user terminal 100 also includes a global positioning system (GPS) sensor 100F, a camera 100G, a touch panel 100H, a display 1001, and a speaker 100J. The location of the first user terminal 100 can be detected by the GPS sensor 100F. Thus, the location of the user P1 using the first user terminal 100 can be identified. The first user terminal 100 may include a microphone and near field communication circuit. The near field communication circuit is a hardware circuit that enables a near field wireless communication such as Bluetooth (registered trademark). The CPU 100A through the speaker 100J are connected to each other through an internal bus 100K. Instead of the CPU 100A, a micro processing unit (MPU) may be used as a processor.

Programs stored in the ROM 100C or the NVM 100D are temporarily stored in the RAM 100B by the CPU 100A. The execution of stored programs by the CPU 100A implements various functions described later and causes various processes described later to be executed. The program is according to the process sequence diagram described later.

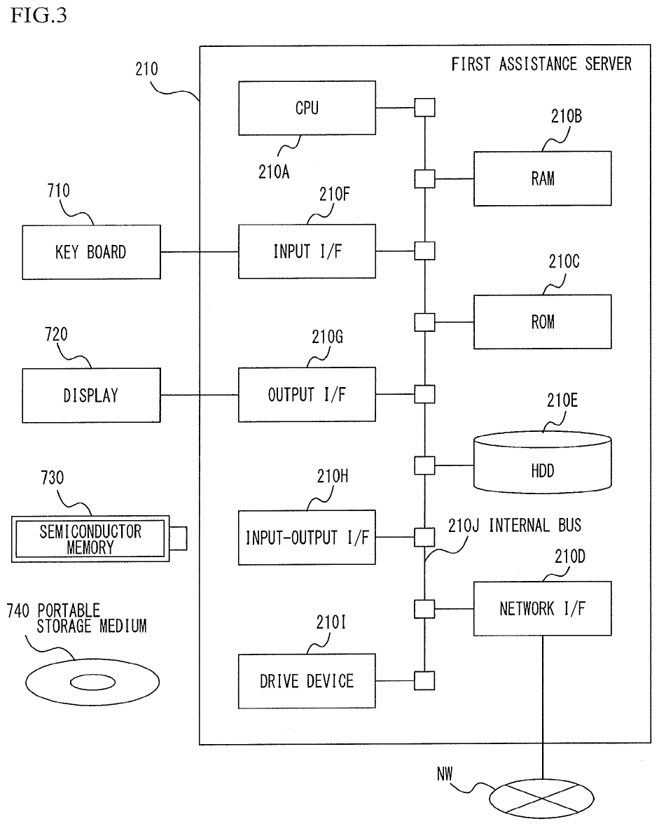

FIG. 3 illustrates a hardware configuration of the first assistance server 210 of the user assistance system 200. The second assistance server 220, the third assistance server 230, and the fourth assistance server 240 of the user assistance system 200 basically have the same hardware configuration as the first assistance server 210. Thus, the description thereof is omitted. The weather server 400 basically has the same hardware configuration as the first assistance server 210. Thus, the description thereof is omitted. As illustrated in FIG. 3, the first assistance server 210 includes at least a CPU 210A as a processor, a RAM 210B, a ROM 210C, and a network interface (I/F) 210D. Instead of the CPU 210A, an MPU may be used as a processor. The first assistance server 210 may include at least one of a hard disk drive (HDD) 210E, an input I/F 210F, an output I/F 210G, an input-output I/F 210H, and a drive device 210I as necessary. The CPU 210A through the drive device 210I are connected to each other through an internal bus 210J.

A keyboard 710 and a mouse (not illustrated) are connected, as input devices, to the input I/F 210F. A display 720 is connected, as a display device, to the output I/F 210G. A semiconductor memory 730 is connected to the input-output I/F 210H. Examples of the semiconductor memory 730 include, but are not limited to, a universal serial bus (USB) memory and a flash memory. The input-output I/F 210H reads programs and data stored in the semiconductor memory 730. The input I/F 210F and the input-output I/F 210H include, for example, USB ports. The output I/F 210G includes, for example, a display port.

A portable storage medium 740 is inserted in the drive device 210I. Examples of the portable storage medium 740 include, but are not limited to, removable discs such as a compact disc (CD)-ROM and a digital versatile disc (DVD). The drive device 210I reads programs and data stored in the portable storage medium 740. The network I/F 210D includes, for example, a LAN port. The network I/F 210D is connected to the communication network NW described above.

Programs stored in the ROM 210C and the HDD 210E are temporarily stored in the above-described RAM 210B by the CPU 210A. Programs stored in the portable storage medium 740 are temporarily stored in the RAM 210B by the CPU 210A. The execution of the stored programs by the CPU 210A implements various functions described later and causes various processes described later to be executed. The programs are according to the process sequence diagram described later.

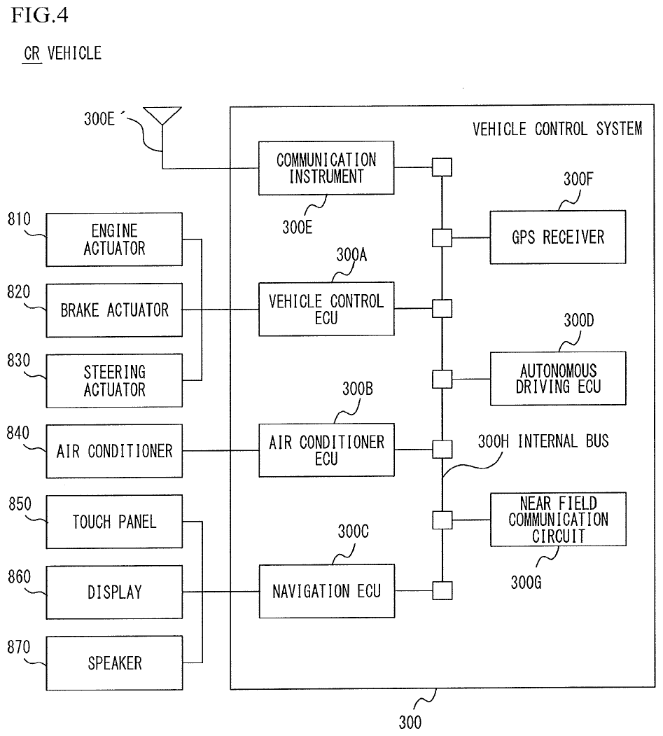

FIG. 4 illustrates a hardware configuration of the vehicle control system 300. As illustrated in FIG. 4, the vehicle control system 300 includes a vehicle control electronic control unit (ECU) 300A, an air conditioner ECU 300B, a navigation ECU 300C, and an autonomous driving ECU 300D. Each of the vehicle control ECU 300A, the air conditioner ECU 300B, the navigation ECU 300C, and the autonomous driving ECU 300D is a hardware device circuit (a so-called microcomputer) including a CPU, a RAM, a ROM, and an input-output I/F. Programs stored in the ROM are temporarily stored in the RAM by the CPU, and the execution of the stored programs by the CPU implements various functions described later, and causes the CPU to execute various processes. The programs are according to the process sequence diagram described later.

The vehicle control system 300 includes a communication instrument (more specifically, a vehicle communication instrument) 300E, a GPS receiver 300F, and a near field communication circuit 300G. For example, a data communication module (DCM) may be used for the communication instrument 300E. An antenna 300E′ is connected to the communication instrument 300E. The vehicle control ECU 300A through the near field communication circuit 300G are connected to each other through an internal bus 300H. Various actuators such as an engine actuator 810, a brake actuator 820, and a steering actuator 830 are connected to the vehicle control ECU 300A. The vehicle control ECU 300A controls the operations of the engine actuator 810, the brake actuator 820, and the steering actuator 830 according to a program. An air conditioner 840 is connected to the air conditioner ECU 300B. The air conditioner ECU 300B controls the operation of the air conditioner 840 according to a program.

A touch panel 850, a display 860, and a speaker 870 are connected to the navigation ECU 300C. The navigation ECU 300C controls the operations of the display 860 and the speaker 870 according to signals input from the touch panel 850 and programs. The autonomous driving ECU 300D has various driving modes and autonomous driving status information corresponding to each driving mode, and sets at least one driving mode to the vehicle control ECU 300A according to a program. The vehicle control ECU 300A controls the operations of the brake actuator 820 and the steering actuator 830 according to the driving mode set to the vehicle control ECU 300A.

The autonomous driving status information is classified into six driving automation levels “0” to “5” according to the degree of driving automation based on the standard defined by Society of Automotive Engineers (SAE). For example, a driving mode (a so-called cruise control function) that reduces a burden on a driver such as a burden of accelerator operation or brakes operation on the driver by following a vehicle driving in front of the vehicle during the traffic jams or during drive on a freeway corresponds to partial automation or conditional automation, which correspond to the driving automation level “2” or the driving automation level “3”, respectively. A driving mode (a so-called parking assistance function) that reduces a burden of steering operation and brakes operation on the driver during parking of a vehicle corresponds to driver assistance or partial automation, which correspond to the driving automation level “1” or the driving automation level “2”, respectively.

A driving mode that allows a vehicle to travel around by remote control by a person other than the driver or a device without a driver performing a driving operation in the vehicle in specific places such as freeways, depopulated areas, or the premises of facilities (for example, a university and an airport) corresponds to high automation, which corresponds to the driving automation level “4”. On a freeway, for example, a mobile shop vehicle goes the rounds of rest areas. In depopulated areas, a vehicle goes the rounds of public facilities (for example, a city hall and community halls). In the premises of facilities, a vehicle goes the rounds of buildings and stops. A driving mode that allows a vehicle to cruise around by remote control by a person other than the driver or a device without a driver performing a driving operation in the vehicle not only in the above described specific places but also in community roads corresponds to full automation, which corresponds to the driving automation level “5”. In the case of the driving automation level “4” or the driving automation level “5”, the vehicle detects persons, bicycles, signs, and signals on the road to make decisions, and cruises.

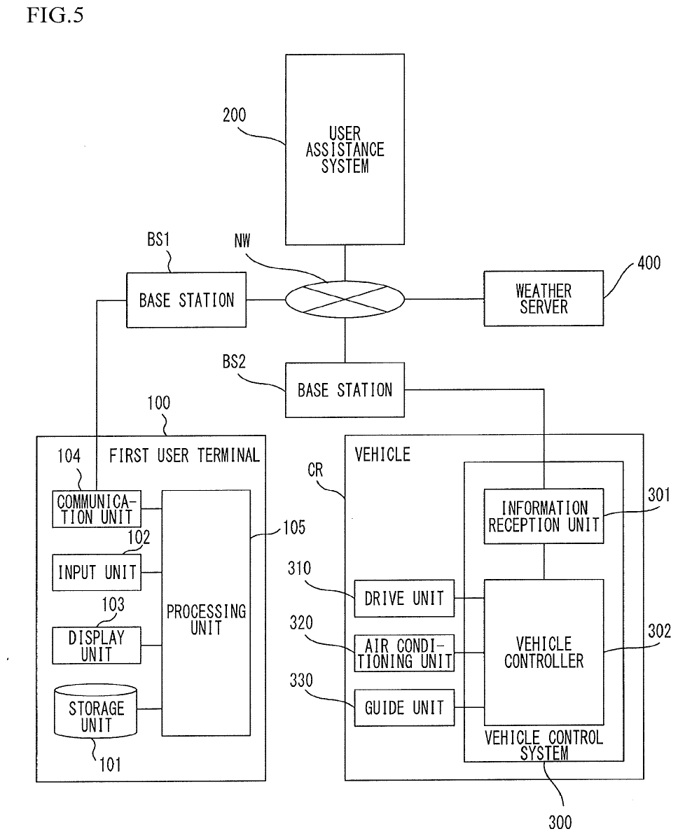

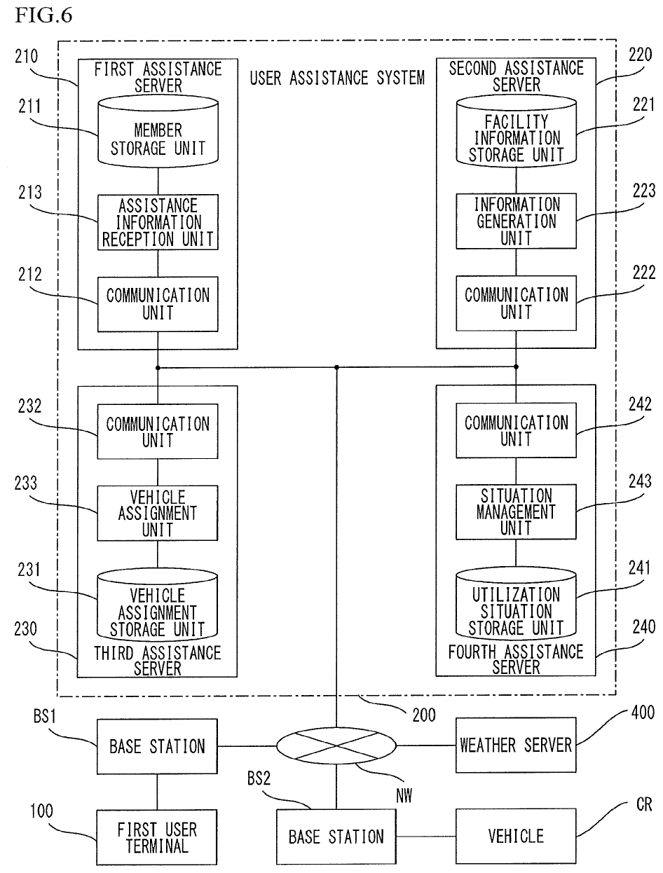

Next, with reference to FIG. 5 and FIG. 6, functions of the first user terminal 100, the user assistance system 200, and the vehicle control system 300 will be described.

FIG. 5 is an exemplary block diagram of the first user terminal 100 and the vehicle control system 300. FIG. 6 is an exemplary block diagram of the user assistance system 200. As illustrated in FIG. 5, the first user terminal 100 includes a storage unit 101, an input unit 102, a display unit 103, a communication unit 104, and a processing unit 105 as its components. The storage unit 101 is implemented by the RAM 100B, the ROM 100C, and the NVM 100D described above. The input unit 102 is implemented by the touch panel 100H described above. The display unit 103 is implemented by the display 1001 and the speaker 100J described above. The communication unit 104 is implemented by the wide area communication circuit 100E described above. The processing unit 105 is implemented by the CPU 100A described above.

The storage unit 101 stores a variety of information and various programs. The information stored in the storage unit 101 includes, for example, information on schedule. The programs stored in the storage unit 101 include, for example, application software (hereinafter, simply referred to as an application) for displaying a screen according to screen information and an application for managing schedule (so-called scheduler). The input unit 102 receives operations by the user P1, generates information according to the received operation, and outputs the generated information to the processing unit 105. The display unit 103 displays various screens or outputs various sounds based on the information output from the processing unit 105. The communication unit 104 controls communication between the first user terminal 100 and the base station BS1. The communication unit 104 receives information transmitted from the base station BS1. The communication unit 104 also transmits the information output from the processing unit 105 to the base station BS1. The processing unit 105 receives information output from the input unit 102 and information received by the communication unit 104, executes a variety of information processing including processing and conversion, and outputs the processed or converted information to the display unit 103. Details of the functions of the input unit 102, the display unit 103, the communication unit 104, and the processing unit 105 will be described later.

Next, the user assistance system 200 will be described. As illustrated in FIG. 6, the first assistance server 210 includes a member storage unit 211, a communication unit 212, and an assistance information reception unit 213. The second assistance server 220 includes a facility information storage unit 221, a communication unit 222, and an information generation unit 223. The third assistance server 230 includes a vehicle assignment storage unit 231, a communication unit 232, and a vehicle assignment unit 233. The fourth assistance server 240 includes a utilization situation storage unit 241, a communication unit 242, and a situation management unit 243.

The member storage unit 211, the facility information storage unit 221, the vehicle assignment storage unit 231, and the utilization situation storage unit 241 are implemented by the RAM 210B and the HDD 210E described above. The four communication units 212, 222, 232, and 242 are implemented by the network I/F 210D described above. The assistance information reception unit 213, the information generation unit 223, the vehicle assignment unit 233, and the situation management unit 243 are implemented by the CPU 210A described above.

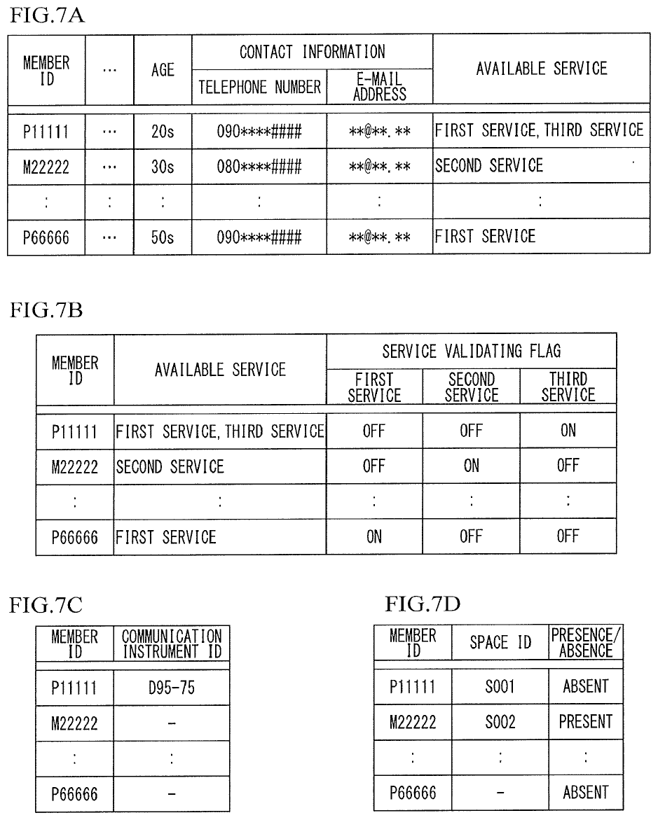

First, the first assistance server 210 will be described. The member storage unit 211 stores membership information. The membership information includes, as illustrated in FIG. 7A, a member ID, an age, a telephone number and an e-mail address as contact information, an available service, and a name (not illustrated). The member ID is an identifier for identifying the member. The member storage unit 211 also stores service management information. The service management information is information for managing a cloud service that members can use, and includes, as illustrated in FIG. 7B, a member ID, an available service, and a service validating flag. The available service is a cloud service that members can use. For example, when a member starts using the first service that is one of cloud services, the service validating flag for the first service is updated from OFF to ON. On the other hand, when the member finishes using the first service, the service validating flag for the first service is updated from ON to OFF. The first embodiment will describe the first service, and the second service and the third service will be described in a second embodiment or thereafter.

The member storage unit 211 further stores vehicle management information and member presence/absence information. The vehicle management information includes, as illustrated in FIG. 7C, a member ID and a communication instrument ID. The communication instrument ID is an identifier for identifying the communication instrument 300E. Thus, the member and the vehicle control system 300 can be associated with each other. That is, the member can be associated with the vehicle CR in which the vehicle control system 300 is installed. The “COMMUNICATION INSTRUMENT ID” field may store the identifier of the communication instrument 300E of the private car of the member, or may store the identifier of the communication instrument 300E of the assigned vehicle. On the other hand, the member presence/absence information includes, as illustrated in FIG. 7D, a member ID, a space ID, and a presence/absence status. The space ID is an identifier for identifying the co-working space 10. Thus, which member uses which co-working space 10 can be identified, and it can be checked whether the member using the co-working space 10 is present in the co-working space 10 or is away and absent from the co-working space 10.

The communication unit 212 receives a variety of information, and outputs the received information to the assistance information reception unit 213, or transmits a variety of information output from the assistance information reception unit 213. The assistance information reception unit 213 receives a variety of information output from the communication unit 212. For example, when the communication unit 212 receives, from the first user terminal 100, assistance information indicating that the user P1 asks for assistance, the assistance information reception unit 213 receives the assistance information received by the communication unit 212. When receiving the assistance information, the assistance information reception unit 213 generates start-up information for starting up the information generation unit 223 and the vehicle assignment unit 233, and outputs the generated start-up information.

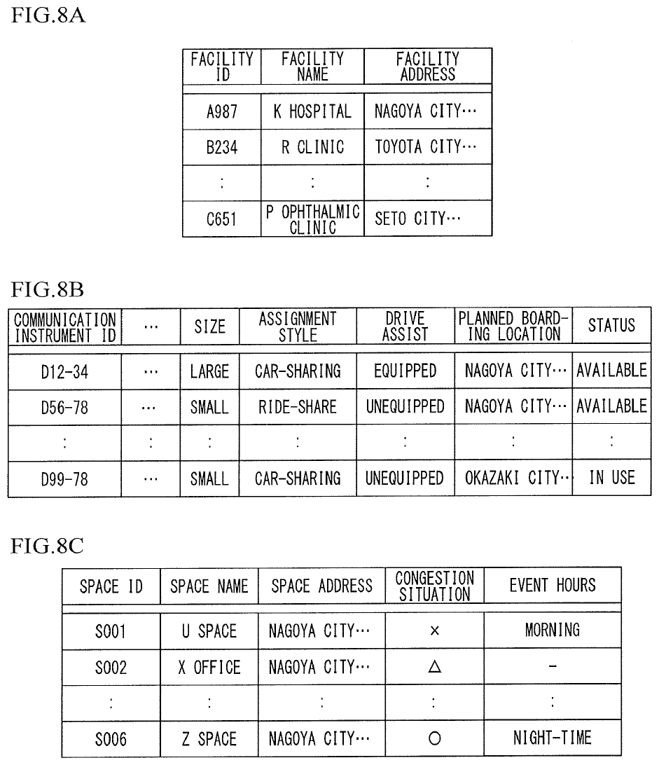

Next, the second assistance server 220 will be described. The facility information storage unit 221 stores facility information. The facility information includes, as illustrated in FIG. 8A, a facility ID, a facility name, and a facility address. The facility ID is an identifier for identifying a facility (more specifically, a medical facility). The communication unit 222 receives a variety of information and outputs the received information to the information generation unit 223, and transmits a variety of information output from the information generation unit 223. The information generation unit 223 executes a variety of information processing based on a variety of information output from the communication unit 222. For example, the information generation unit 223 generates control information for controlling the vehicle CR that the user P1 is going to get on based on the start-up information output from the communication unit 222.

Next, the third assistance server 230 will be described. The vehicle assignment storage unit 231 stores vehicle assignment information about the vehicle CR to be assigned. The vehicle assignment information includes, as illustrated in FIG. 8B, a communication instrument ID, a size, an assignment style, drive assist, a planned boarding location, a status, and a vehicle name (not illustrated). Car-sharing or ride-share is stored in the “ASSIGNMENT STYLE” field. The “DRIVE ASSIST” field stores whether a vehicle is equipped with a driving assistance function. When a vehicle is equipped with the driving assistance function, a specific driving mode may be stored. The “PLANNED BOARDING LOCATION” field stores the address of a car station in the case of car-sharing. In the case of ride-share, the address of the garage of the vehicle CR or the location to which the user asked to deliver the vehicle is stored. The “STATUS” field stores whether the vehicle CR to be assigned is available. For example, the vehicle CR to be assigned is already assigned, “in use” is stored in the “STATUS” field. The communication unit 232 receives a variety of information and outputs the received information to the vehicle assignment unit 233, and transmits a variety of information output from the vehicle assignment unit 233. The vehicle assignment unit 233 executes a variety of information processing based on a variety of information output from the communication unit 232. For example, the vehicle assignment unit 233 assigns the vehicle CR to the user P1 based on the start-up information output from the communication unit 232.

Next, the fourth assistance server 240 will be described. The utilization situation storage unit 241 stores utilization situation information on the utilization status of the co-working space 10. The utilization situation information includes, as illustrated in FIG. 8C, a space ID, a space name, a space address, a congestion situation, and event hours. The space ID is an identifier for identifying the co-working space 10 as described above. The “CONGESTION SITUATION” field stores a degree of congestion of the co-working space 10 at the current time. For example, when the co-working space 10 is fully attended, a cross mark is stored in the “CONGESTION SITUATION” field. When the degree of congestion of the co-working space 10 (for example, the ratio of the number of vacant seats to the number of seats) is 50% or less, a circle is stored in the “CONGESTION SITUATION” field. When neither of a circle and a cross mark is stored in the “CONGESTION SITUATION” field, a triangle is stored in the “CONGESTION SITUATION” field. On the other hand, the hours for an event to be held in the co-working space 10 is stored in the “EVENT HOURS” field. Thus, the hours for an event to be held in the co-working space 10 can be identified. The communication unit 242 receives a variety of information and outputs the received information to the situation management unit 243, and transmits a variety of information output from the situation management unit 243. The situation management unit 243 executes a variety of information processing based on a variety of information output from the communication unit 242. For example, the situation management unit 243 obtains the utilization situation information from the utilization situation storage unit 241 based on the information output from the communication unit 242, and outputs the utilization situation information to the communication unit 242.

Next, the vehicle control system 300 will be described. As illustrated in FIG. 5, the vehicle control system 300 includes an information reception unit 301 and a vehicle controller 302 as its components. The information reception unit 301 is implemented by the communication instrument 300E described above. The vehicle controller 302 is implemented by the vehicle control ECU 300A, the air conditioner ECU 300B, the navigation ECU 300C, and the autonomous driving ECU 300D described above.

The information reception unit 301 receives control information transmitted from the user assistance system 200, and outputs the received control information to the vehicle controller 302. The vehicle controller 302 controls the vehicle CR based on the control information output from the information reception unit 301. In more details, the vehicle controller 302 controls a drive unit 310, an air conditioning unit 320, and a guide unit 330 of the vehicle CR based on the control information output from the information reception unit 301. The drive unit 310 is implemented by the engine actuator 810, the brake actuator 820, and the steering actuator 830. The air conditioning unit 320 is implemented by the air conditioner 840. The guide unit 330 is implemented by the display 860 and the speaker 870.

Next, the operations of the first user terminal 100, the user assistance system 200, and the vehicle control system 300 will be described.

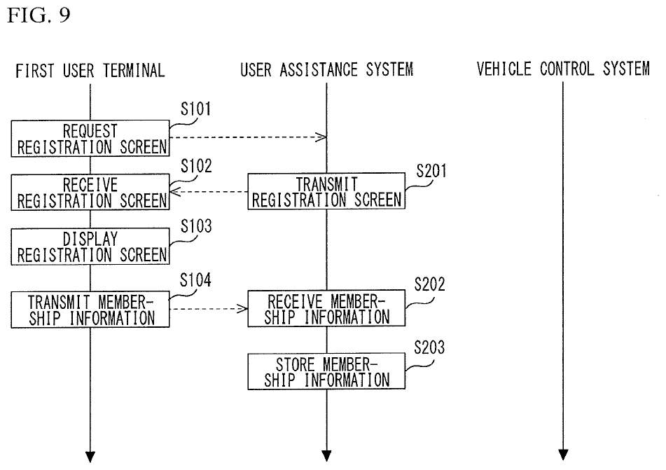

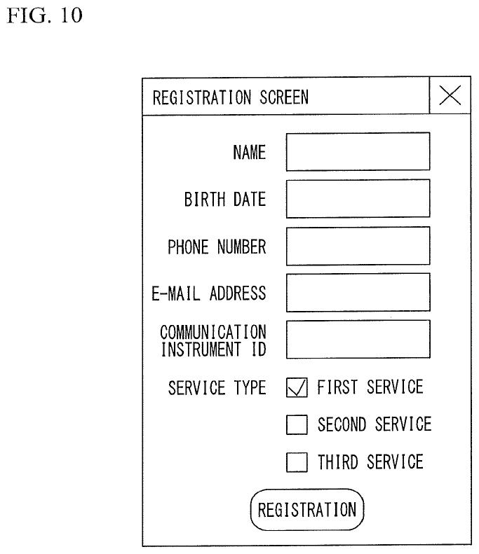

With reference to FIG. 9 and FIG. 10, a process of registering the membership information described above will be described. FIG. 9 is an exemplary sequence diagram of a first process in accordance with the first embodiment. FIG. 10 illustrates a registration screen. To use various services of the user assistance system 200, the user P1 registers the membership information including the name and the birth date of the user P1 with the user assistance system 200 in advance. More specifically, when the user P1 operates the input unit 102 of the first user terminal 100 to start registration of the membership information, the processing unit 105 requests the registration screen from the user assistance system 200 as illustrated in FIG. 9 (step S101). When the registration screen is requested to the user assistance system 200, the communication unit 212 of the first assistance server 210 transmits screen information on the registration screen to the first user terminal 100 (step S201). The communication unit 104 of the first user terminal 100 receives the screen information on the registration screen (step S102)

When the communication unit 104 receives the screen information on the registration screen, the processing unit 105 outputs the screen information to the display unit 103. As illustrated in FIG. 10, the display unit 103 displays the registration screen with use of an application (step S103). The user P1 operates the input unit 102 to input a variety of information from the name to the communication instrument ID included in the registration screen, select a service (for example, the first service), and press a registration button in sequence. When the processing unit 105 detects that the registration button is pressed, the communication unit 104 transmits the membership information including the input variety of information and the selected service to the user assistance system 200 (step S104). The communication unit 212 of the first assistance server 210 receives the membership information (step S202).

When the communication unit 212 receives the membership information, the assistance information reception unit 213 generates a member ID, and stores the membership information associated with the generated member ID in the member storage unit 211 (step S203). The member storage unit 211 stores the membership information (see FIG. 7A). In the case of the first service and the third service, the assistance information reception unit 213 generates a member ID including a specific character (for example, “P”), which allows the first service and the third service to be distinguished from the second service, at the first character of the member ID.

When storing the membership information, the assistance information reception unit 213 generates the service management information, the vehicle management information, and the member presence/absence information and stores them in the member storage unit 211. Accordingly, the member storage unit 211 stores the service management information (see FIG. 7B), the vehicle management information (see FIG. 7C), and the member presence/absence information (see FIG. 7D). When the communication instrument ID is not input in the registration screen because the user P1 does not have a private car, the assistance information reception unit 213 generates the vehicle management information in which “-” is stored in the “COMMUNICATION INSTRUMENT ID” field. When the user P1 has not started using the co-working space 10 yet, the assistance information reception unit 213 generates the member presence/absence information in which “-” is stored in the “SPACE ID” field.

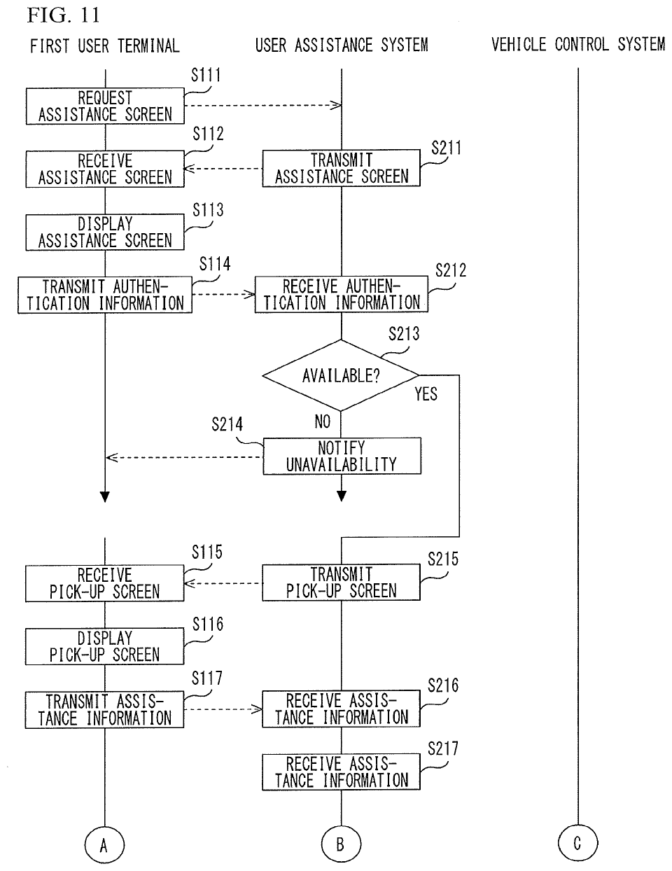

Next, with reference to FIG. 11 to FIG. 16, the process for the first service will be described.

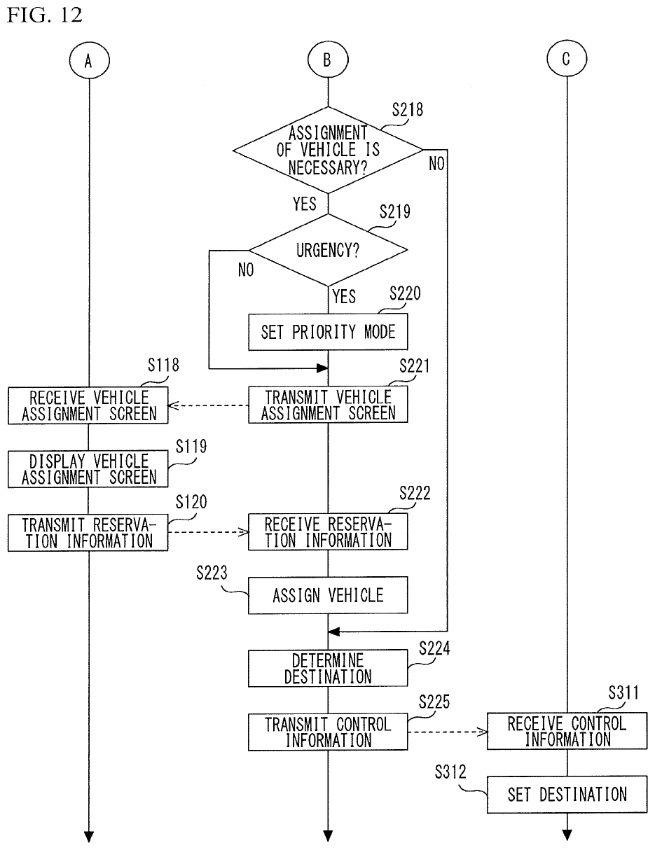

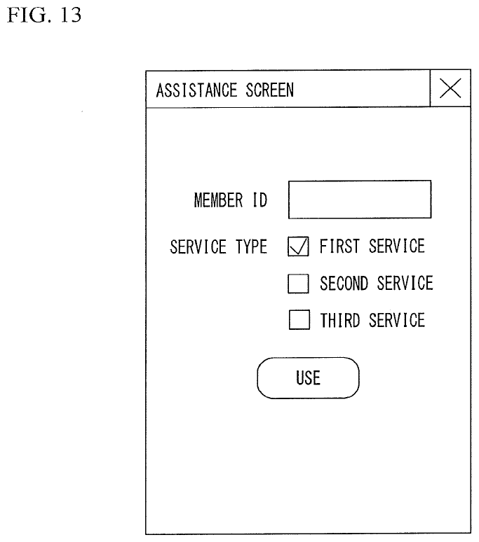

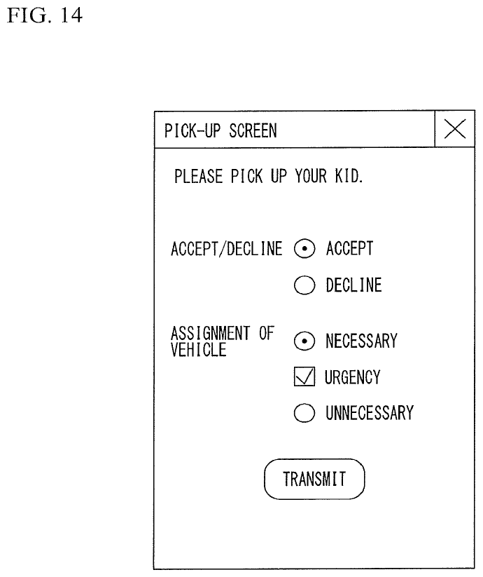

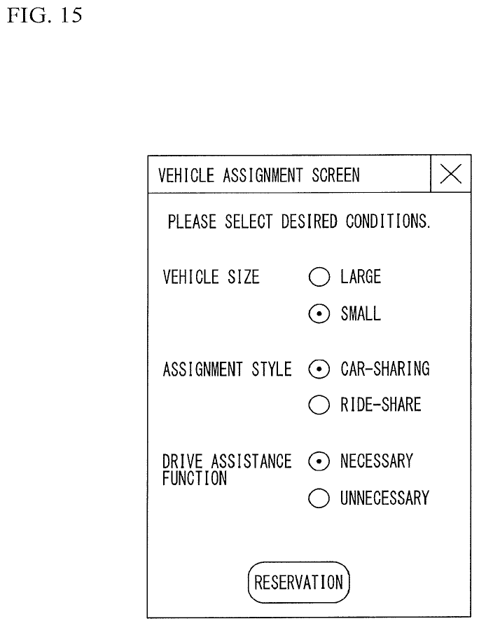

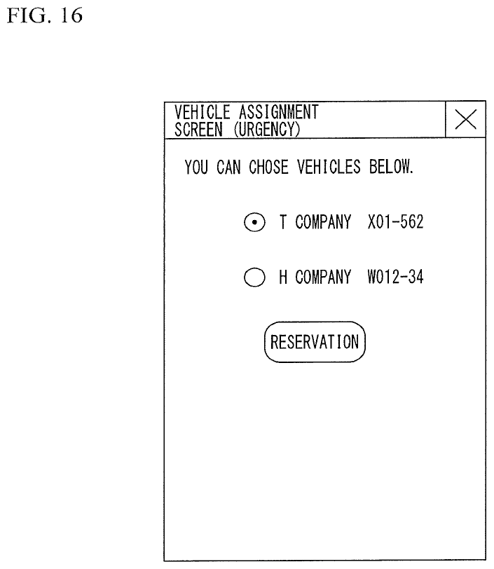

FIG. 11 is an exemplary sequence diagram (No. 1) of a second process in accordance with the first embodiment. FIG. 12 is an exemplary sequence diagram (No. 2) of the second process in accordance with the first embodiment. FIG. 13 illustrates an assistance screen. FIG. 14 illustrates a pick-up screen. FIG. 15 illustrates a vehicle assignment screen. FIG. 16 illustrates another example of the vehicle assignment screen.

First, a case where the user P1 uses the first service will be described. The user P1 goes to the co-working space 10 with the kid Kd, leaves the kid Kd at the day-care center attached to the co-working space 10, and uses the co-working space 10. When the user P1 starts using the co-working space 10, the assistance information reception unit 213 inputs the space ID and the presence/absence status into the member presence/absence information. The assistance information reception unit 213 inputs the space ID and the presence/absence status based on the operations on the first user terminal 100 by the user P1. For example, when a sensor for detecting the entrance and exit of the user P1 is installed in the co-working space 10, the assistance information reception unit 213 may input the space ID and the presence/absence status based on the information indicating the entrance of the user P1 detected by the sensor.

When the user P1 leaves the co-working space 10 for certain reasons, the assistance information reception unit 213 updates the presence/absence status while maintaining the stored value in the “SPACE ID” field based on the operation by the user P1 or information indicating the exit of the user P1 detected by the sensor. In the above-described situation, when the kid Kd becomes ill and the nursery staff at the day-care center calls the user P1 to request the user P1 to pick up the kid Kd, the user P1 starts using the first service.

The user P1 operates the input unit 102 of the first user terminal 100 to start using the first service. When the user P1 conducts the operation for staring the use of the first service, the processing unit 105 requests the assistance screen from the user assistance system 200 as illustrated in FIG. 11 (step S111). When the user assistance system 200 receives the request of the assistance screen, the communication unit 212 of the first assistance server 210 transmits screen information on the assistance screen to the first user terminal 100 (step S211). The communication unit 104 of the first user terminal 100 receives the screen information on the assistance screen (step S112).

When the communication unit 104 receives the screen information on the assistance screen, the processing unit 105 outputs the screen information to the display unit 103. Thus, as illustrated in FIG. 13, the display unit 103 displays the assistance screen with use of an application (step S113). The user P1 operates the input unit 102 to input information such as the member ID included in the assistance screen, select a service (for example, the first service), and press a use button in sequence. When the processing unit 105 detects that the use button is pressed, the communication unit 104 transmits authentication information including the input information and the selected service to the user assistance system 200 (step S114). The communication unit 212 of the first assistance server 210 receives the authentication information (step S212).

When the communication unit 212 receives the authentication information, the assistance information reception unit 213 determines whether the service is available (step S213). In more detail, the assistance information reception unit 213 accesses the member storage unit 211 to obtain the membership information, and determines whether the combination of the member ID and the service included in the authentication information is included in the membership information. When determining that the combination of the member ID and the service is not included in the membership information, the assistance information reception unit 213 determines that the service is not available (step S213:NO). In this case, the assistance information reception unit 213 notifies the first user terminal 100 that the service is unavailable (step S214), and ends subsequent processing.

On the other hand, when determining that the combination of the member ID and the service is included in the membership information, the assistance information reception unit 213 determines that the service is available (step S213: YES). In this case, the communication unit 212 transmits screen information on the pick-up screen to the first user terminal 100 (step S215). The communication unit 104 of the first user terminal 100 receives the screen information on the pick-up screen (step S115).

When the communication unit 104 receives the screen information on the pick-up screen, the processing unit 105 outputs the screen information to the display unit 103. Thereby, as illustrated in FIG. 14, the display unit 103 displays the pick-up screen with use of an application (step S116). The user P1 operates the input unit 102 to select whether to accept or decline to pick up the kid Kd, select whether there is urgency, select whether assignment of a vehicle is necessary or unnecessary, and press a transmit button in sequence in the pick-up screen. When the processing unit 105 detects that the transmit button is pressed, the communication unit 104 transmits the assistance information including two selected options and the situation of urgency to the user assistance system 200 (step S117). The communication unit 212 of the first assistance server 210 receives the assistance information (step S216).

When the communication unit 212 receives the assistance information and the assistance information includes information indicating that the user P1 accepts to pick up the kid Kd, the assistance information reception unit 213 receives the assistance information (step S217). When the assistance information reception unit 213 receives the assistance information, the information generation unit 223 of the second assistance server 220 determines whether assignment of a vehicle is necessary based on the assistance information received by the assistance information reception unit 213 as illustrated in FIG. 12 (step S218). More specifically, the information generation unit 223 determines whether assignment of a vehicle is necessary based on information on assignment of a vehicle included in the assistance information.

When the assistance information includes information indicating that assignment of a vehicle is necessary (step S218: YES), the information generation unit 223 determines whether there is urgency (step S219). More specifically, the information generation unit 223 determines whether there is urgency based on the information indicating presence or absence of urgency included in the assistance information. When the assistance information includes the information indicating that there is urgency (step S219: YES), the vehicle assignment unit 233 sets a priority mode that preferentially assigns the vehicle CR (step S220). In this case, the vehicle assignment unit 233 to which the priority mode is set accesses the vehicle assignment storage unit 231 to obtain the vehicle assignment information. The vehicle assignment unit 233 generates screen information including names of vehicles having the status “available”, and outputs the generated screen information to the communication unit 232. When there is no vehicle having the status “available” in the vehicle assignment information, the vehicle assignment unit 233 may request the user terminal of the user who made a reservation of the vehicle to be assigned to cancel the reservation. On the other hand, when information indicating that there is urgency is not included in the assistance information (step S219: NO), the process in the step S220 is skipped. In this case, a non-priority mode that is initially set to the vehicle assignment unit 233 is maintained. The non-priority mode is a mode that assigns the vehicle CR based on desired conditions.

When the process in step S220 is skipped, or the process in step S220 is executed, the communication unit 232 transmits screen information on the vehicle assignment screen (step S221). In more detail, the communication unit 232 transmits the screen information on the vehicle assignment screen corresponding to the priority mode or the non-priority mode set to the vehicle assignment unit 233. The communication unit 104 of the first user terminal 100 receives the screen information on the vehicle assignment screen (step S118).

When the communication unit 104 receives the screen information on the vehicle assignment screen, the processing unit 105 outputs the received screen information to the display unit 103. The display unit 103 displays the vehicle assignment screen with use of an application (step S119). In particular, when the processing unit 105 outputs the screen information on the vehicle assignment screen corresponding to the non-priority mode, the display unit 103 displays the vehicle assignment screen corresponding to the non-priority mode as illustrated in FIG. 15. On the other hand, when the processing unit 105 outputs the screen information on the vehicle assignment screen corresponding to the priority mode, the display unit 103 displays the vehicle assignment screen corresponding to the priority mode as illustrated in FIG. 16. As described above, since the vehicle assignment screen changes according to presence or absence of urgency, the user P1 can select the vehicle CR smoothly.

The user P1 operates the input unit 102 to select the size of the vehicle, select the assignment style, select whether the driving assistance function is necessary, and push a reservation button in sequence in the vehicle assignment screen. When the processing unit 105 detects that the reservation button is pressed, the communication unit 104 transmits reservation information including the selected size of the vehicle, the assignment style, and presence or absence of the driving assistance function to the user assistance system 200 (step S120). The communication unit 232 of the third assistance server 230 receives the reservation information (step S222).

When the communication unit 232 receives the reservation information, the vehicle assignment unit 233 assigns the vehicle CR (step S223). In more detail, the vehicle assignment unit 233 accesses the vehicle assignment storage unit 231 to obtain information on vehicles that satisfy the vehicle size, the assignment style, and presence or absence of the driving assistance function included in the reservation information and have an “available” status. Then, the vehicle assignment unit 233 identifies, from the obtained information on vehicles, the communication instrument ID of the vehicle of which the planned boarding location is nearest to the address of the co-working space 10, and assigns the vehicle CR of the vehicle control system 300 including the communication instrument 300E to which the identified communication instrument ID is assigned.

When the vehicle assignment unit 233 assigns the vehicle CR, the information generation unit 223 determines a destination (step S224). In more detail, the information generation unit 223 requests the space ID of the co-working space 10 that the user P1 is using from the first assistance server 210, and accesses the facility information storage unit 221 based on the space ID. Then, the information generation unit 223 determines, as a destination, the address of the nearest medical facility to the address of the co-working space 10 that the user P1 is using. When the information generation unit 223 can obtain the information on the medical facility at which the family doctor of the kid Kd is present, the address of that medical facility may be determined as a destination. When the vehicle assignment unit 233 assigns the vehicle CR, the information generation unit 223 determines the destination of the vehicle CR assigned by the vehicle assignment unit 233. On the other hand, when the assistance information does not include information indicating that assignment of a vehicle is necessary (step S218: NO) in the process of step S218, the information generation unit 223 determines that the user P1 has a private car, and determines the destination of the vehicle CR of the user P1.

When the information generation unit 223 determines the destination, the information generation unit 223 generates control information including the destination, and the communication unit 222 transmits the control information generated by the information generation unit 223 to the vehicle control system 300 (step S225). The control information is information for controlling the vehicle CR that the user P1 is going to get on. When the user P1 has a private car, the communication unit 222 transmits the control information to the vehicle control system 300 included in the vehicle CR of the user P1. On the other hand, when the user P1 will use the assigned vehicle CR, the communication unit 222 transmits control information to the vehicle control system 300 included in the assigned vehicle CR. Thus, the information reception unit 301 of the vehicle control system 300 receives the control information (step S311). When the information generation unit 223 can obtain traffic condition information, the traffic condition information may be included in the control information.

When the information reception unit 301 receives the control information, the vehicle controller 302 sets the destination included in the control information to the vehicle controller 302 (step S312) In addition, when the vehicle controller 302 sets the destination, the vehicle controller 302 sets the current location of the vehicle CR as the point of departure to the vehicle controller 302 based on the GPS information, generates routing information of the shortest route from the point of departure to the destination including a through place, and outputs the generated routing information to the guide unit 330. The shortest route may be a route with the minimum time, or may be a route with the shortest distance. The guide unit 330 displays a guide screen including the shortest route from the point of departure to the destination. Thus, it is possible to avoid the trouble of the user P1 operating the guide unit 330 and searching for a route from the co-working space 10 to the nearest medical facility. Thus, when the user P1 returns to the co-working space 10 to pick up the kid Kd and then gets on the vehicle CR, the user P1 can smoothly move to the medical facility.

An exemplary case where the user P1 accepts to pick up the kid Kd has been described. However, for example, the user P1 may decline to pick up the kid Kd by the user P1 themselves, and may request another user using the co-working space 10 to pick up the kid Kd instead of the user P1. In this case, when the assistance information reception unit 213 determines that the assistance information includes the contact information of another user together with information indicating that pick-up of the kid Kd is declined and information indicating that assignment of a vehicle is necessary in the process of step S217, the communication unit 212 transmits screen information on the pick-up screen to the user terminal of another user. When the assistance information transmitted from the user terminal of another user includes information indicating that the another user accepts to pick up the kid Kd, the communication unit 212 transmits, to the user terminal of the another user, the information for unlocking the assigned vehicle CR. This configuration allows the substitute person for the user P1 to pick up the kid Kd left in care of the day-care center by the user P1 and move to the medical facility.

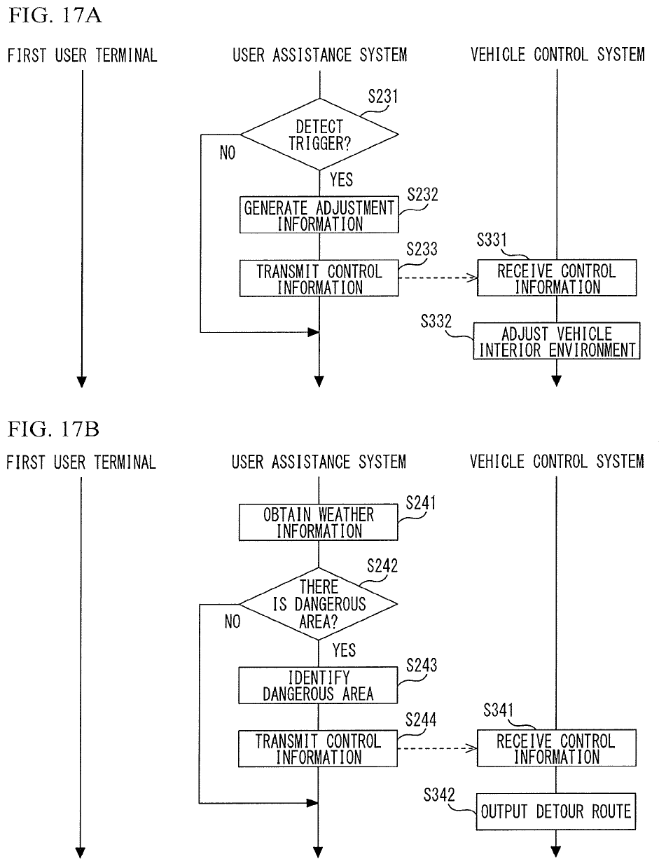

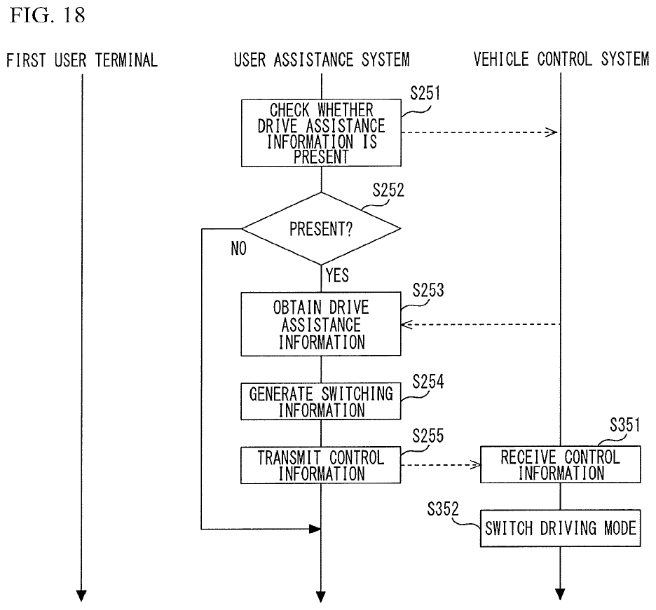

Next, as illustrated in FIG. 17 and FIG. 18, another control of the vehicle CR as the first service will be described.

FIG. 17A is an exemplary sequence diagram of a third process. The third process is executed in parallel to the processes in and after step S223 when the process in step S222, in which the reservation information described above is received, is completed. Alternatively, when it is determined that assignment of a vehicle is not necessary in the process in step S218, in which whether assignment of a vehicle is necessary is determined, the third process is executed in parallel to the processes in and after step S218. As illustrated in FIG. 17A, the information generation unit 223 of the second assistance server 220 included in the user assistance system 200 determines whether a predetermined trigger is detected (step S231).

The predetermined trigger may be, for example, reception of the reservation information by the communication unit 222, or may be completion of picking-up of the kid Kd by the user P1. In this case, the user P1 operates the first user terminal 100 to transmit, from the first user terminal 100, information indicating completion of picking up of the kid Kd to the user assistance system 200. Alternatively, when the assigned vehicle CR has a driving mode of the driving automation level “5”, the predetermined trigger may be the approach of the assigned vehicle CR to the co-working space 10. In this case, the information generation unit 223 detects that the assigned vehicle CR comes within a predetermined distance such as several kilometers from the address of the co-working space 10 based on the GPS information of the assigned vehicle CR.

When determining that the predetermined trigger is not detected (step S231: NO), the information generation unit 223 skips subsequent processing, and ends the process. On the other hand, when determining that the predetermined trigger is detected (step S231: YES), the information generation unit 223 generates adjustment information (step S232). The adjustment information is information for adjusting the environment in the interior of the vehicle CR. The adjustment of the environment in the vehicle interior includes, for example, rising or reducing the temperature in the vehicle interior, and reducing the humidity in the vehicle interior.

When the information generation unit 223 generates the adjustment information, the communication unit 222 transmits control information including the adjustment information (step S233). The information reception unit 301 of the vehicle control system 300 receives the adjustment information (step S331). When the information reception unit 301 receives the control information, the vehicle controller 302 adjusts the vehicle interior environment (step S332). In more detail, the vehicle controller 302 controls the air conditioning unit 320 based on the adjustment information included in the control information. Thus, for example, even when the interior of the vehicle CR has an indoor environment that may cause heatstroke, such as in summer, the indoor environment has already been adjusted when the user P1 and the kid Kd gets on the vehicle CR. Thus, the user P1 and the kid Kd can smoothly and comfortably move to the medical facility.

FIG. 17B is an exemplary sequence diagram of a fourth process. The fourth process is executed in parallel to the processes in and after step S223 when the process in step S222 for receiving the above-described reservation information is completed. Alternatively, the fourth process is executed in parallel to the processes in and after step S218 when it is determined that assignment of a vehicle is unnecessary in the process of step S218, in which whether assignment of a vehicle is necessary is determined. As illustrated in FIG. 17B, the information generation unit 223 of the second assistance server 220 included in the user assistance system 200 obtains weather information (step S241). The information generation unit 223 can obtain the weather information from the weather server 400.

When obtaining the weather information, the information generation unit 223 determines whether there is a dangerous area based on the obtained weather information (step S242). For example, the information generation unit 223 determines whether there is a dangerous area that has blinding rain or road surface freezing based on the temperature and precipitation included in the weather information. When determining that there is no dangerous area (step S242: NO), the information generation unit 223 skips subsequent processing, and ends the process. On the other hand, when determining that there is a dangerous area (step S242: YES), the information generation unit 223 identifies the dangerous area (step S243). When the information generation unit 223 identifies the dangerous area, the communication unit 222 transmits control information including the dangerous area to the vehicle control system 300 (step S244). Thus, the information reception unit 301 of the vehicle control system 300 receives the control information (step S341).

When the information reception unit 301 receives the control information, the vehicle controller 302 outputs a detour route (step S342). In more detail, the vehicle controller 302 outputs, to the guide unit 330, route information for going around the dangerous area based on the dangerous area included in the control information. Then, the guide unit 330 displays a guide screen including the shortest route from the point of departure to the destination not passing through the dangerous area. Accordingly, it is possible to go around a rough road caused by weather conditions, and the occurrence of accidents while the vehicle is moving is inhibited.

FIG. 18 is an exemplary sequence diagram of a fifth process. The fifth process is executed in parallel to the processes in and after step S223 when the process of step S222 for receiving the reservation information is completed. Alternatively, the fifth process is executed in parallel to the processes in and after step S218 when it is determined that assignment of a vehicle is unnecessary in the process of step S218, in which whether assignment of a vehicle is necessary is determined. As illustrated in FIG. 18, the information generation unit 223 of the second assistance server 220 included in the user assistance system 200 checks whether driving assistance information is present with the vehicle control system 300 (step S251). The driving assistance information may be the various driving modes described above, or may be the autonomous driving status information.

The information generation unit 223 checks whether there is the driving assistance information. When determining that the driving assistance information is absent (step S252: NO), the information generation unit 223 skips subsequent processing, and ends the process. On the other hand, when determining that the driving assistance information is present (step S252: YES), the information generation unit 223 obtains the driving assistance information from the vehicle control system 300 (step S253). When obtaining the driving assistance information, the information generation unit 223 generates switching information (step S254). The switching information is information for switching the first driving mode that does not use the driving assistance information to the second driving mode that uses the driving assistance information. When the information generation unit 223 generates the switching information, the communication unit 222 transmits control information including the switching information to the vehicle control system 300 (step S255). The information reception unit 301 of the vehicle control system 300 receives the control information (step S351).

When the information reception unit 301 receives the control information, the vehicle controller 302 switches the driving mode (step S352). In more detail, the vehicle controller 302 switches the first driving mode set to the vehicle controller 302 to the second driving mode based on the switching information included in the control information, and then controls the drive unit 310. This configuration inhibits erroneous driving operations that may be caused by impatience or anxiety of the user P1 who is driving the vehicle CR.

As described above, the user assistance system 200 of the first embodiment includes the assistance information reception unit 213, the information generation unit 223, and the communication unit 222. The assistance information reception unit 213 receives the assistance information indicating that the user P1 asks for assistance from the first user terminal 100 used by the user P1 of the co-working space 10 in which the user P1 can work in cooperation with other users. When the assistance information reception unit 213 accepts the assistance information, the information generation unit 223 generates the control information for controlling the vehicle CR used by the user P1. The communication unit 222 transmits the control information to the vehicle CR. Thus, the smooth transportation of the user P1 of the co-working space 10 from the co-working space 10 is assisted.

In particular, the user assistance system 200 of the first embodiment includes the facility information storage unit 221 that stores the facility information including the location of the medical facility to which the kid Kd left in care by the user P1 can be taken. When the assistance information reception unit 213 receives the assistance information including acceptance of picking up of the kid Kd, the information generation unit 223 determines, as a destination, the location of the medical facility at which the user P1 is going to get out of the vehicle CR based on the facility information. The communication unit 222 transmits the control information including the destination. Accordingly, the smooth transportation of the user P1 of the co-working space 10 to the medical facility can be assisted. The vehicle CR used by the user P1 may be a private car that the user P1 is going to get on, or may be an assigned vehicle.

### Second Embodiment

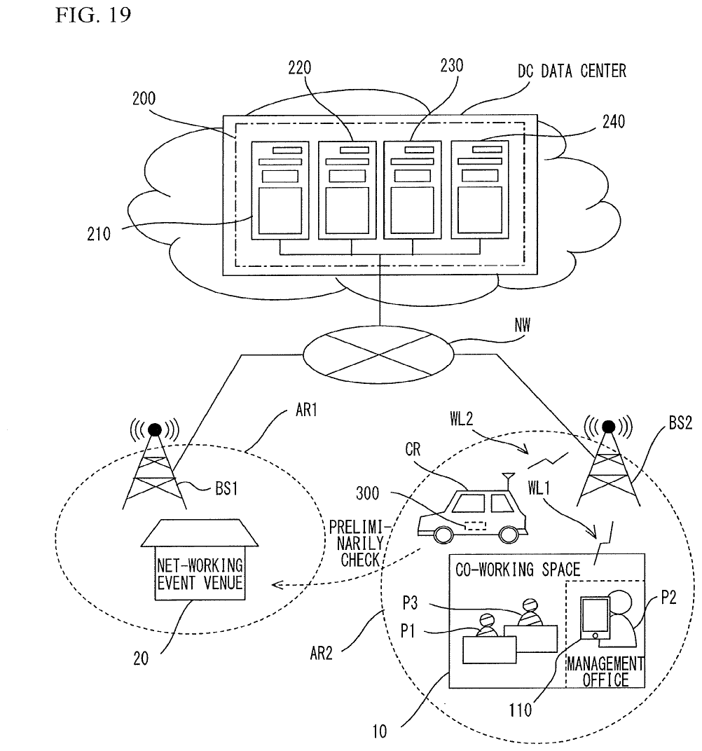

Next, with reference to FIG. 19 through FIG. 22, the second embodiment of the present disclosure will be described.

FIG. 19 is a diagram for describing examples of the user assistance system 200 and the vehicle control system 300 in accordance with the second embodiment. The same reference numerals are assigned to the components identical to the components illustrated in FIG. 1, and the description thereof is omitted. In the second embodiment, a second service for a user P2 will be described.

A second user terminal 110 is used by the user P2 of the co-working space 10. The hardware configuration and the functional configuration of the second user terminal 110 are basically the same as those of the first user terminal 100. The user P2 is a community manager, and does various business assignments such as assisting community-building of the above-described user P1 and a user P3 illustrated in FIG. 19 while using the co-working space 10. When the business assignments increase, the operations of the user P2 may become busy.

When the user P2 assists community-building among users including the user P1 and the user P3, the user P2 organizes a networking event among the users as a business assignment. In this case, when the co-working space 10 is not suitable for a venue for the networking event, the user P2 reserves a networking event venue 20 such as a banquet hall of a hotel, and registers schedule information including the reservation date and the reserved location for the networking event with the second user terminal 110. As necessary, the user P2 goes to preliminarily check the networking event venue 20 with use of the vehicle CR.

The user assistance system 200 obtains the schedule information registered on the second user terminal 110, determines the location included in the obtained schedule information as a destination, and transmits control information including the determined destination to the vehicle control system 300 of the vehicle CR. When receiving the control information transmitted from the user assistance system 200, the vehicle control system 300 sets the destination included in the control information. Accordingly, the time and effort for the user P2 to set the destination can be omitted, and the user P2 can move smoothly to the networking event venue 20 while the work load of the user P2 is reduced.

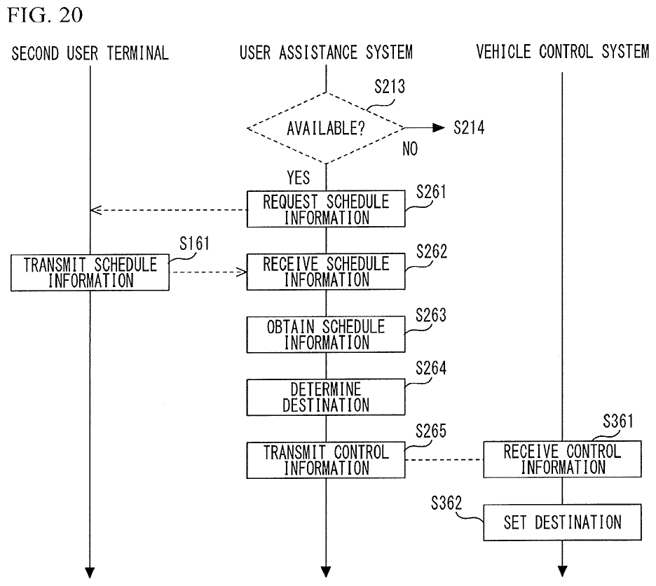

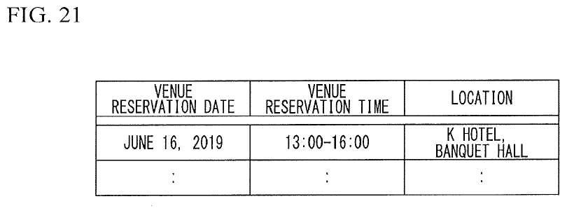

With reference to FIG. 20 and FIG. 21, operations of the second user terminal 110, the user assistance system 200, and the vehicle control system 300 will be described. The registration process of the membership information using the second user terminal 110 is basically identical to the registration process in the sequence diagram of the first process illustrated in FIG. 9, and the description thereof is thus omitted. The processes from steps S111 to S114 and the processes from steps S211 to S212 illustrated in FIG. 11 are basically the same except that the second service is selected in the assistance screen (see FIG. 13), and the description thereof is thus omitted.

FIG. 20 is an exemplary sequence diagram of the first process in accordance with the second embodiment. FIG. 21 illustrates schedule information. As illustrated in FIG. 20, in the process of step S213, when determining that the combination of the member ID and the service is included in the membership information, the assistance information reception unit 213 receives the membership information as the assistance information, and determines that the service is available. In this case, the information generation unit 223 of the second assistance server 220 included in the user assistance system 200 requests the schedule information from the second user terminal 110 (step S261). When the schedule information is requested, the processing unit (not illustrated) of the second user terminal 110 obtains the schedule information stored in the storage unit (not illustrated) of the second user terminal 110, and outputs the obtained schedule information to the communication unit (not illustrated) of the second user terminal 110. Then, the communication unit 104 transmits the schedule information to the user assistance system 200 (step S161). The communication unit 222 receives the schedule information (step S262).

When the communication unit 222 receives the schedule information, the information generation unit 223 obtains the schedule information from the communication unit 222 (step S263). When the information generation unit 223 obtains the schedule information, the information generation unit 223 determines a destination (step S264). In more detail, when obtaining the schedule information, the information generation unit 223 determines the location included in the schedule information as a destination.

When the information generation unit 223 determines the destination, the information generation unit 223 generates control information including the destination, and the communication unit 222 transmits the control information generated by the information generation unit 223 to the vehicle control system 300 (step S265). The control information is information for controlling the vehicle CR that the user P2 is going to get on. After the information generation unit 223 determines the destination, screen information for asking whether assignment of a vehicle is necessary may be transmitted to the second user terminal 110 before the communication unit 222 transmits the control information. When the user P2 has a private car and the information generation unit 223 obtains information indicating that assignment of a vehicle is unnecessary, the communication unit 222 transmits the control information to the vehicle control system 300 included in the vehicle CR of the user P2. On the other hand, when the user P2 wants assignment of the vehicle CR, and the information generation unit 223 obtains information indicating that assignment of a vehicle is necessary, the communication unit 222 transmits the control information to the vehicle control system 300 of the assigned vehicle CR. The information reception unit 301 of the vehicle control system 300 receives the control information (step S361).

When the information reception unit 301 receives the control information, the vehicle controller 302 sets the destination included in the control information to the vehicle controller 302 (step S362). When setting the destination, the vehicle controller 302 sets the current location of the vehicle CR as the point of departure to the vehicle controller 302, generates route information on the shortest route from the point of departure to the destination including a through point, and outputs the generated route information to the guide unit 330. The guide unit 330 displays a guide screen including the shortest route from the point of departure to the destination. Thus, the time and effort for the user P2 to operate the guide unit 330 to search for a route from the co-working space 10 to the networking event venue 20 can be omitted.

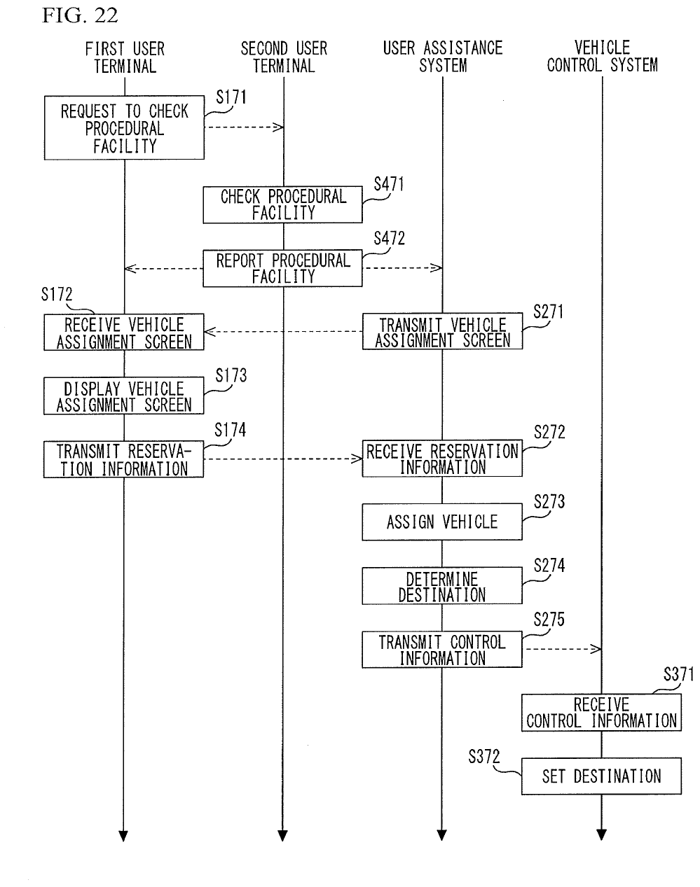

Next, with reference to FIG. 22, other operations of the second user terminal 110, the user assistance system 200, and the vehicle control system 300 will be described.

The user P2 may be consulted about starting a business by the user P1 or the user P3. More specifically, the user P2 may be consulted about documents necessary for establishment of a company. In this case, the user P2 operates the second user terminal 110 to check the documents necessary for establishment of a company, and procedural facilities including the place where the documents can be obtained and the place at which the documents are to be submitted, and tells the checked contents to the user P1 and the user P3. The user P1 or the user P3 moves to the procedural facilities by the vehicle CR based on the contents told from the user P2. In such cases, the user assistance system 200 assists the user P1 or the user P3 by the second service.

FIG. 22 is an exemplary sequence diagram of the second process in accordance with the second embodiment. As illustrated in FIG. 22, the processing unit 105 of the first user terminal 100 requests the second user terminal 110 to check a procedural facility based on the operation of the user P1 on the input unit 102 (step S171). When the check of the procedural facility is requested, the processing unit of the second user terminal 110 checks the procedural facility based on the operation of the user P2 on the input unit (not illustrated) of the second user terminal 110 (step S471). The processing unit of the second user terminal 110 checks the procedural facility, and then reports the checked procedural facility to the first user terminal 100 and the user assistance system 200 (step S472).

When the procedural facility is reported to the user assistance system 200, the communication unit 232 of the third assistance server 230 transmits screen information on the vehicle assignment screen to the first user terminal 100 (step S271). The communication unit 104 of the first user terminal 100 receives the screen information on the vehicle assignment screen (step S172). When the communication unit 104 receives the screen information on the vehicle assignment screen, the processing unit 105 outputs the received screen information to the display unit 103. The display unit 103 displays the vehicle assignment screen with use of an application (step S173).

The user P1 conducts various operations described in the first embodiment and an operation to press a reservation button to the input unit 102. When the processing unit 105 detects that the reservation button is pressed, the communication unit 104 transmits the reservation information to the user assistance system 200 (step S174). The communication unit 212 of the first assistance server 210 receives the reservation information (step S272).

When the communication unit 212 receives the reservation information, the assistance information reception unit 213 receives the reservation information as the assistance information, and the vehicle assignment unit 233 assigns the vehicle CR (step S273). When the vehicle assignment unit 233 assigns the vehicle CR, the information generation unit 223 determines a destination (step S274). For example, the information generation unit 223 determines, as a destination, the address of the nearest procedural facility to the co-working space 10 that the user P1 is using. When the vehicle assignment unit 233 assigns the vehicle CR, the information generation unit 223 determines the destination of the vehicle CR assigned by the vehicle assignment unit 233.

When the information generation unit 223 determines the destination, the information generation unit 223 generates control information including the destination, and the communication unit 222 transmits the control information generated by the information generation unit 223 to the vehicle control system 300 (step S275). The control information is information for controlling the vehicle CR that the user P1 is going to get on. When the user P1 uses the assigned vehicle CR, the communication unit 222 transmits the control information to the vehicle control system 300 of the assigned vehicle CR. The information reception unit 301 of the vehicle control system 300 receives the control information (step S371).

When the information reception unit 301 receives the control information, the vehicle controller 302 sets the destination included in the control information to the vehicle controller 302 (step S372). When setting the destination, the vehicle controller 302 sets the current location of the vehicle CR as the point of departure based on the GPS information, generates route information on the shortest route from the point of departure to the destination including a through point, and outputs the generated route information to the guide unit 330. The guide unit 330 displays the guide screen including the shortest route from the point of departure to the destination. Thus, the time and effort for the user P1 to operate the guide unit 330 to search for a route from the co-working space 10 to the nearest procedural facility can be avoided. As described above, the user assistance system 200 can assist the user P1, and the user P1 can smoothly move to the procedural facility if the user P1 gets on the vehicle CR. When vacant houses provided by estate companies or local governments or mobile vehicles CR such as camper vans are used as the co-working space 10 instead of the procedural facility, the same method as the method described with reference to FIG. 20 can be employed.

A case where the user P2 and the user P1 are assisted has been described, but the adjustment information and the switching information described in the first embodiment may be employed in the second embodiment. When the second embodiment employs the adjustment information, the indoor environment has been already adjusted when the user P2 or the user P1 gets on the vehicle CR, and the user P2 or the user P1 can smoothly move to the networking event venue 20 or the procedural facility. The employment of the switching information in the second embodiment lessens burden on the user P2 during drive. More specifically, when the vehicle CR has a cruise control function and a parking assistance function described in the first embodiment, burden on the user P2 during drive can be lessened by fulfilling these functions by the switching information.

The user assistance system 200 may manage profile information of the user P1 and the user P3 in advance, and may transmit the profile information to the assigned vehicle CR of the user P1 and the vehicle CR of the user P3 when receiving the reservation information from the first user terminal 100 and the user terminal of the user P3. The vehicle control system 300 of the vehicle CR outputs the profile information to the guide unit 330. Thus, the user P1 and the user P3 can know their profile before arriving at the networking event venue 20. The vehicle assignment screen may be prepared in the second user terminal 110 in advance, and the reservation information including the options selected on the vehicle assignment screen may be transmitted to the user assistance system 200 together with the schedule information stored in the second user terminal 110. This configuration allows the location included in the schedule information to be set to the vehicle CR to be assigned if the user P2 selects the desirable conditions, and omits the operation to set the destination to the vehicle CR by the user P2.

As described above, the user assistance system 200 of the second embodiment can also assist the smooth transportation of the user P2 of the co-working space 10 as with the first embodiment. In particular, when the assistance information reception unit 213 receives the assistance information, the information generation unit 223 obtains, from the second user terminal 110, the schedule information including the schedules of the user P2 managed by the second user terminal 110, and determines the location included in the schedule as a destination. The communication unit 222 transmits the control information including the destination. This configuration assists smooth transportation of the user P2 of the co-working space 10 to the destination place included in the schedule information.

### Third Embodiment

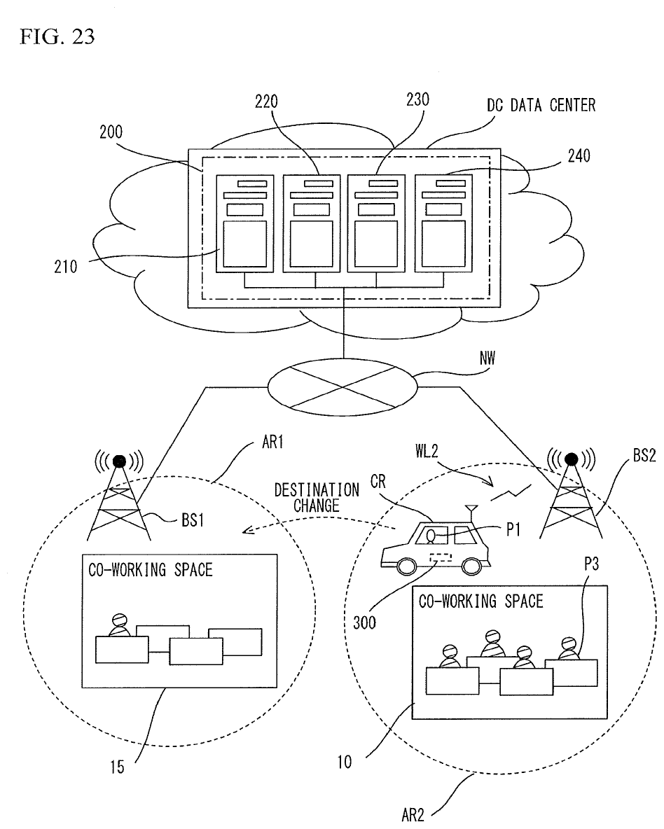

Next, with reference to FIG. 23 through FIG. 27, a third embodiment of the present disclosure will be described.

FIG. 23 is a diagram for describing examples of the user assistance system 200 and the vehicle control system 300 in accordance with the third embodiment. The same reference numerals are assigned to the components identical to the components illustrated in FIG. 1, and the description thereof is omitted. The third embodiment will describe a third service for the user P1.

As illustrated in FIG. 23, the co-working space 10 that the user P1 who have gotten on the vehicle CR is heading to may be congested. In this case, when the user P1 operates the first user terminal 100 to use the third service, the user assistance system 200 provides a screen for checking the utilization situation of the co-working space 10 to the first user terminal 100. When the user P1 operates the first user terminal 100 to change the destination from the co-working space 10 to another less-congested co-working space 15, the user assistance system 200 transmits control information including a new destination. When the vehicle control system 300 of the vehicle CR receives the control information transmitted from the user assistance system 200, the vehicle control system 300 sets the new destination included in the control information to the vehicle control system 300. Thus, the user P1 is guided to the new destination, and the user P1 can smoothly move to another co-working space 15.

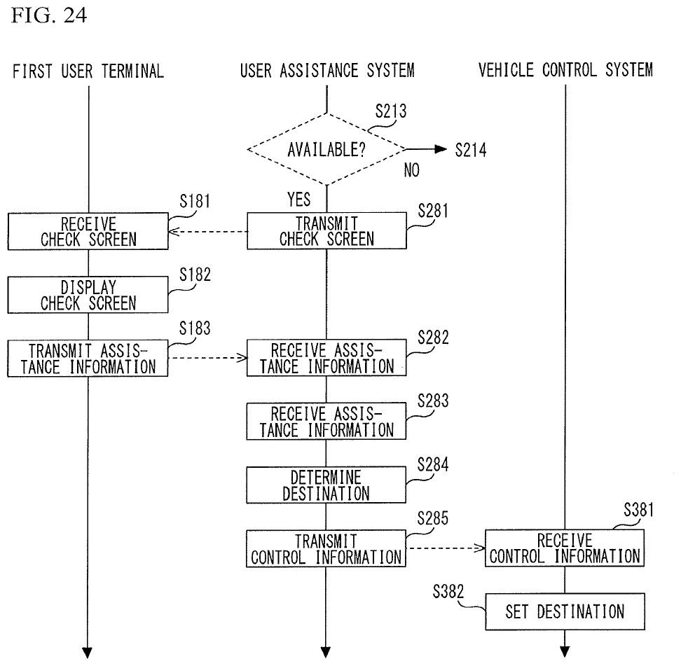

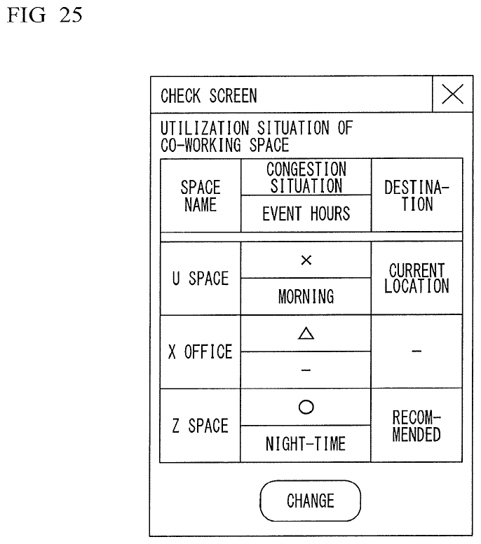

Next, with reference to FIG. 24 and FIG. 25, operations of the first user terminal 100, the user assistance system 200, and the vehicle control system 300 will be described.

FIG. 24 is an exemplary sequence diagram of the first process in accordance with the third embodiment. FIG. 25 illustrates a check screen. As illustrated in FIG. 24, when the assistance information reception unit 213 determines that the combination of the member ID and the service is included in the membership information in step S213, the assistance information reception unit 213 determines that the service is available. In this case, the situation management unit 243 of the fourth assistance server 240 obtains the utilization situation information stored in the utilization situation storage unit 241. The communication unit 242 transmits, to the first user terminal 100, screen information on the check screen together with the utilization situation information (step S281). The communication unit 104 of the first user terminal 100 receives the screen information on the check screen together with the utilization situation information (step S181).

When the communication unit 104 receives the screen information on the check screen together with the utilization situation information, the processing unit 105 outputs the screen information together with the utilization situation information to the display unit 103. As illustrated in FIG. 25, the display unit 103 displays the check screen including the utilization situation with use of an application (step S182). The user P1 checks the utilization situation such as the congestion situation and event hours, and operates the input unit 102 to select one of the space names included in the check screen and press a change button in sequence. When the processing unit 105 detects that the change button is pressed, the communication unit 104 transmits assistance information including the selected space name to the user assistance system 200 (step S183). The communication unit 212 of the first assistance server 210 receives the assistance information (step S282).

When the communication unit 212 receives the assistance information, the assistance information reception unit 213 receives the assistance information (step S283). When the assistance information reception unit 213 receives the assistance information, the situation management unit 243 determines a destination (step S284). In more detail, the situation management unit 243 obtains the assistance information received by the assistance information reception unit 213, extracts, from the utilization situation storage unit 241, the space address corresponding to the space name included in the assistance information, and determines the extracted space address as a destination.

When the situation management unit 243 determines the destination, the information generation unit 223 generates the control information including the destination, and the communication unit 222 transmits control information generated by the information generation unit 223 to the vehicle control system 300 (step S285). The control information is information for controlling the vehicle CR that the user P1 is riding. The information reception unit 301 of the vehicle control system 300 receives the control information (step S381).

When the information reception unit 301 receives the control information, the vehicle controller 302 sets the destination included in the control information to the vehicle controller 302 (step S382). In addition, when setting the destination, the vehicle controller 302 sets the current location of the vehicle CR as the point of departure to the vehicle controller 302 based on the GPS information, generates route information on the shortest route from the point of departure to the destination including a through point, and outputs the generated route information to the guide unit 330. Accordingly, the guide unit 330 displays the guide screen including the shortest route from the point of departure to the destination. Thus, the destination can be changed to another co-working space 15 as a new destination even while the user P1 is heading for the co-working space 10 that is the original destination.

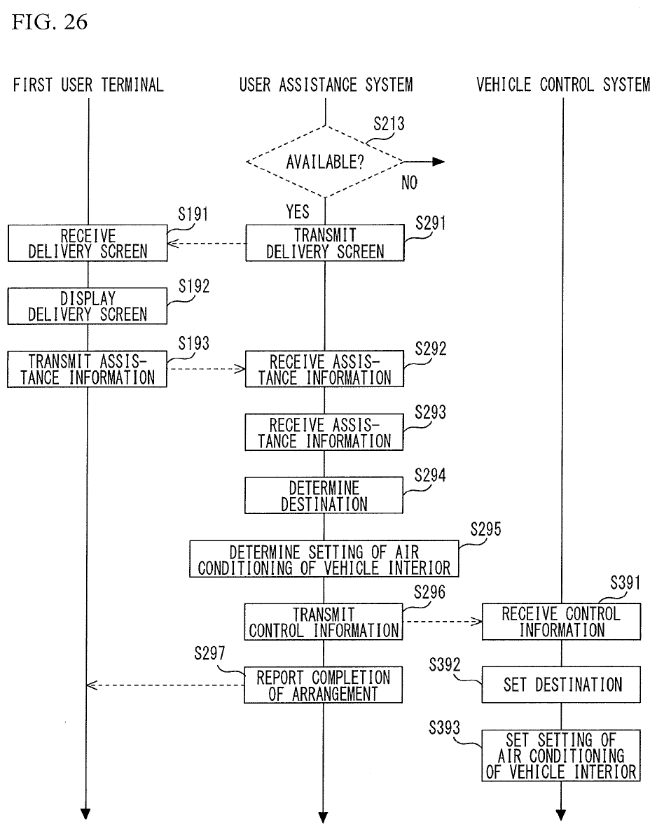

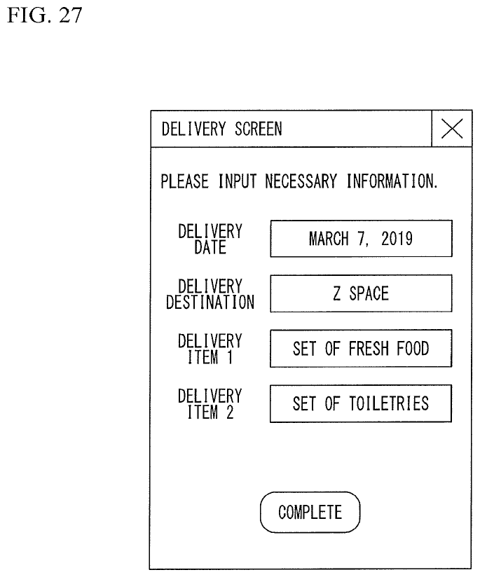

Next, with reference to FIG. 26 and FIG. 27, operations of the first user terminal 100, the user assistance system 200, and the vehicle control system 300 will be described.

FIG. 26 illustrates an exemplary sequence diagram of the second process in accordance with the third embodiment. FIG. 27 illustrates a delivery screen. As illustrated in FIG. 26, when determining that the combination of the member ID and the service is included in the membership information in step S213, the assistance information reception unit 213 determines that the service is available. In this case, the communication unit 212 transmits screen information on the delivery screen to the first user terminal 100 (step S291). The communication unit 104 of the first user terminal 100 receives the screen information on the delivery screen (step S191).

When the communication unit 104 receives the screen information on the delivery screen, the processing unit 105 outputs the screen information to the display unit 103. As illustrated in FIG. 27, the display unit 103 displays the delivery screen with use of an application (step S192) The user P1 operates the input unit 102 to input necessary information to entry fields included in the delivery screen and press a complete button in sequence. When the processing unit 105 detects that the complete button is pressed, the communication unit 104 transmits, to the user assistance system 200, the assistance information including the input necessary information (step S193). The communication unit 212 of the first assistance server 210 receives the assistance information (step S292).

When the communication unit 212 receives the assistance information, the assistance information reception unit 213 receives the assistance information (step S293). When the assistance information reception unit 213 receives the assistance information, the situation management unit 243 determines the destination (step S294).

In more detail, the situation management unit 243 obtains the assistance information received by the assistance information reception unit 213, extracts, from the utilization situation storage unit 241, the space address corresponding to the delivery destination included in the assistance information, and determines the extracted space address as a destination.

When the situation management unit 243 determines the destination, the situation management unit 243 determines the setting for interior air conditioning (step S295). In more detail, the situation management unit 243 obtains the assistance information received by the assistance information reception unit 213, and determines the setting of the interior air conditioning taking into consideration the storage of the delivery item included in the assistance information and the comfortableness of the driver with respect to each delivery item. For example, when the delivery item is fresh food, the situation management unit 243 determines the set value of the temperature of the interior air conditioning at 5° C. to 10° C. to avoid decrease in the degree of freshness by high temperature.

When the situation management unit 243 determines the setting of the interior air conditioning, the information generation unit 223 generates control information including the destination and the setting of the interior air conditioning, and the communication unit 222 transmits the control information generated by the information generation unit 223 to the vehicle control system 300 (step S296). The control information is information for controlling the vehicle CR used by the user P1 for delivery to the destination. The vehicle CR may be a delivery van that a producer or a distributor handling fresh food and commodities has, or may be a truck of a carrier undertaking the delivery entrusted by the producer or the distributor. The delivery van or the truck may have or may not necessarily have the autonomous driving status information of the driving automation level “4” or the driving automation level “5”. The information reception unit 301 of the vehicle control system 300 receives the control information (step S391). When the communication unit 222 transmits the control information, the information generation unit 223 reports completion of the arrangement for the delivery item to the first user terminal 100 (step S297).

When the information reception unit 301 receives the control information, the vehicle controller 302 sets the destination included in the control information to the vehicle controller 302 (step S392). In addition, the vehicle controller 302 sets the setting of the interior air conditioning included in the control information to the vehicle controller 302 (step S393). When setting the destination, the vehicle controller 302 sets the current location of the vehicle CR as the point of departure based on the GPS information, generates route information on the shortest route from the point of departure to the destination including a through point, and outputs the generated route information to the guide unit 330. The vehicle controller 302 sets the setting of the interior air conditioning to the vehicle controller 302, and outputs the setting of the interior air conditioning to the air conditioning unit 320.

Accordingly, the guide unit 330 displays the guide screen including the shortest route from the point of departure to the destination. Thus, even when the user P1 does not tell the details of the delivery destination to the producer, the distributer, or the carrier, the necessary delivery item is delivered to the co-working space 10. In addition, the air conditioning unit 320 controls the interior of the vehicle CR to achieve the environment taking into account the storage of the delivery item and the comfortableness of the driver, the delivery item is delivered without deteriorating while the comfortableness of the driver is kept.

In particular, when a delivery van or a truck has the autonomous driving status information of the driving automation level “4” or the driving automation level “5”, the vehicle controller 302 generates the route information to control the drive unit 310. Accordingly, the necessary delivery item is delivered while the driver is absent from the delivery van or the truck.

As described above, the user assistance system 200 of the third embodiment can also assist the smooth transportation of the user P1 of the co-working space 10 as in the first embodiment and the second embodiment. In particular, the user assistance system 200 includes the situation management unit 243 that manages the utilization situation information including the utilization situation of the co-working space 10. The information generation unit 223 provides the utilization situation to the first user terminal 100 of the user P1 who is going to use the co-working space 10 based on the utilization situation information, and when detecting that the co-working space 10 to be used is changed to another co-working space 15, determines the co-working space 15 as a destination from the current location of the user P1. The communication unit 222 transmits the control information including the destination. Accordingly, even when the user P1 of the co-working space 10 changes the destination, the smooth transportation of the user P1 can be assisted.

Although some embodiments of the present disclosure have been described in detail, the present disclosure is not limited to the specific embodiments but may be varied or changed within the scope of the present disclosure as claimed. For example, the first embodiment through the third embodiment may be carried out in combination as appropriate. When the information generation unit 223 determines that the first user terminal 100 is located in the interior of the vehicle CR, the communication unit 212 may transmit the control information including the destination to the first user terminal 100. This configuration allows even the vehicle CR without the guide unit 330 to assist the user P1.

Furthermore, at least one of the first assistance server 210, the second assistance server 220, the third assistance server 230, and the fourth assistance server 240 may be installed in the site different from the data center DC. Furthermore, the functions of the first assistance server 210, the second assistance server 220, the third assistance server 230, and the fourth assistance server 240 may be integrated in one server, and the one server may implement the cloud service. Furthermore, the functions may be integrated in two servers, and the two servers may implement the cloud service in cooperation with each other.

What is claimed is:

1. A user assistance system comprising:
an assistance information reception unit configured to receive, from a user terminal of a user who uses a place where the user works in cooperation with another user, assistance information indicating that the user asks for assistance;
an information generation unit configured to generate control information for controlling a vehicle to be used by the user when the assistance information reception unit receives the assistance information; and
a communication unit configured to transmit the control information to the vehicle.

2. The user assistance system according to claim 1, further comprising
a facility information storage unit configured to store facility information including a location of a medical facility to which a person who is left in care by the user can be taken, wherein
the information generation unit determines, as a destination, a location of a medical facility where the user is to get out of the vehicle based on the facility information when the assistance information reception unit receives the assistance information including information indicating that picking up of the person who is left in care by the user is accepted, and
the communication unit transmits the control information including the destination.

3. The user assistance system according to claim 1, wherein
the information generation unit obtains, from the user terminal, schedule information including a schedule of the user managed by the user terminal and determines, as a destination, a destination location included in the schedule based on the schedule information when the assistance information reception unit receives the assistance information, and
the communication unit transmits the control information including the destination.

4. The user assistance system according to claim 1, further comprising
a situation management unit configured to manage utilization situation information including a utilization situation of the place, wherein
the information generation unit provides the utilization situation to the user terminal of which a user is to use the place based on the utilization situation information, and when detecting that the place that the user is to use is changed to another place where the user works in cooperation with another user, determines the another place as a destination from a current location of the user, and
the communication unit transmits the control information including the destination.

5. The user assistance system according to claim 2, further comprising:
a vehicle assignment unit configured to assign the vehicle to the user based on an operation to request assignment of the vehicle on the user terminal, wherein
the communication unit transmits, to the vehicle that is assigned, the control information including the destination when assignment of the vehicle is completed.

6. The user assistance system according to claim 5, wherein
the information generation unit determines whether the assistance information includes information indicating that there is urgency of assignment of the vehicle when the assistance information reception unit receives the assistance information, and
when determining that the assistance information includes the information indicating that there is urgency of assignment of the vehicle, the information generation unit sets, to the vehicle assignment unit, a priority mode that preferentially assigns the vehicle.

7. The user assistance system according to claim 2, wherein
the information generation unit obtains weather information, and when determining that a route from a planned boarding location of the user to the destination includes a dangerous driving environment based on the weather information, identifies the dangerous driving environment, and
the communication unit transmits the control information including the dangerous driving environment.

8. The user assistance system according to claim 2, wherein
the communication unit transmits, to the user terminal, the control information including the destination when the information generation unit determines that the user terminal is located in an interior of the vehicle.

9. The user assistance system according to claim 1, wherein
the information generation unit obtains, from the vehicle, driving assistance information for assisting the user in driving the vehicle, and when determining that the driving assistance information is present, generates switching information for switching from a first driving mode, which does not use the driving assistance information, to a second driving mode, which uses the driving assistance information, and
the communication unit transmits the control information including the switching information.

10. The user assistance system according to claim 1, wherein
the information generation unit generates adjustment information for adjusting an environment in an interior of the vehicle when detecting a trigger for adjusting the environment in the interior of the vehicle, and
the communication unit transmits the control information including the adjustment information.

11. A vehicle control system comprising:
an information reception unit configured to receive, from a user assistance system that generates control information for controlling a vehicle to be used by a user and transmits the control information to the vehicle when receiving assistance information indicating that the user asks for assistance from a user terminal of the user who uses a place where the user works in cooperation with another user, the control information; and
a vehicle controller configured to control the vehicle based on the control information.
